(19) United States
(12) Patent Application Publication
(10) Pub. No.: US 2005/0256734 A1
(43) Pub. Date: Nov. 17, 2005

(54) Method and data structure for augmenting invention and analysis of intellectual property

(76) Inventor: Richard Roy Clikeman, Doylestown, PA (US)

Correspondence Address: Richard R. Clikeman, 157 Hart Ave., Doylestown, PA, 18901, US

(21) Appl. No.: 11/128,463

(22) Filed: May 13, 2005

Related U.S. Application Data
(60) Provisional application No. 60/571,555, filed on May 14, 2004.

(51) Int. Cl. G06F 17/60

(52) U.S. Cl. 705/1

(57) ABSTRACT

A method for augmenting the analysis of intellectual property and augmenting invention based upon that analysis is disclosed. The method includes forming awareness grids from which decisions regarding novelty, obviousness, and right to practice can be made. The method further includes combining awareness grids to form synaptic grids from which inventive concepts may be created, and gap analysis using awareness grids. Awareness grids, awareness databases, and synaptic grids are also disclosed.

The present patent application derives priority from U.S. provisional patent application Ser. No. 60/571,555, filed May 14, 2004.

The present invention relates to a method for augmenting the analysis of intellectual property and for augmenting invention based upon that analysis.

Commonly, a host of problems attend the inventive process. Those problems include: slow evolution of inventive concepts; inability to accurately shape a nascent inventive concept into the form of an invention; inability to move beyond incremental improvement; difficulty including patent professionals in the inventive process during the early stages of invention, and even before invention occurs; ineffectual brain storming sessions with little follow through; the lack of full inclusion of information professionals, especially search professionals, in the inventive process; the lack of a truly fertile environment in which the would-be inventor can become immersed; and the difficulty of bringing two or more inventive people together, either in the same location or virtually, to move an invention forward, in the full light of the detailed intellectual property environment surrounding the inventive concepts at hand. Effective connection of the creative mind to the detailed intellectual property environment remains a challenging problem slowing the process of invention, and confusing attempts to protect inventive concepts.

Those laboring in the realm of invention and innovation are familiar with the difficulties attending attempts to understand the intellectual property landscape in a particular technology area. Though daunting, the task of achieving such understanding is only one facet of a larger effort toward creation, protection, and commercialization of new inventions.

Commercial databases exist which provide information on patents and related documents. It is possible to collect information from these databases in various formats designed to address the needs of inventors and patent practitioners alike. It is now possible to download information including, for example, extended titles, abstracts, full text, classification information, and data on inventors, authors, assignees, priority dates, publication dates, and other identifiers regarding individuals and companies involved in invention and other scientific and technical activities, as well as timeline data.

Numerous text mining and citation searching processes are disclosed in the literature. For example, U.S. Pat. No. 6,665,670 is directed to a method and system for determining the likely uniqueness and novelty of a subject concept of, for example, a patent, in comparison with disclosures of other published references embodying other concepts by using forward and backward citation searching to identify references, and then analyzing information regarding each reference, comparing that information with the subject concept. The information being compared includes such fields as patent identifying number, assignee, patent classification code, patent term remaining until expiration, patent filing date and patent issue date. While compilation and comparison of such information, available on commercial databases, is useful, the information represents, at best, no more than a superficial guide to nature of the inventive concept(s) disclosed in the references at issue. In spite of advances in the accessibility of patent related information, inventors, patent practitioners, information specialists, managers, opportunity specialists, venture specialists, and licensing specialists have a continuing frustration that available database information is not ordered, stored, and available in a way that affords them the sort of detailed, explicit understanding of individual inventive concepts that can be quickly assimilated, analyzed, and shared, let alone built upon by the inventive mind to create new inventive concepts. In short, existing databases and data mining techniques, though targeted at understanding the inventive concepts disclosed and claimed in documents, have settled for categorizing and analyzing characteristics of those documents (e.g., metadata) and characteristics of specific words and word strings found in those documents, yet identification, explicit description, and detailed comparison of the inventive concepts themselves remains an elusive goal. The structure of existing databases and the methods by which they are assembled preclude description of the actual inventive concepts contained in the documents analyzed.

I have, surprisingly, discovered a method for describing, assimilating, and analyzing inventive concepts, and, further, for forming new inventive concepts. The present invention includes: forming an awareness grid that includes dimensions by which the inventive concepts of a selected area of technology can be described; adding grid records that include a claimed field and a disclosed field for each grid dimension of the awareness grid; and populating the claimed fields and disclosed fields with awareness values describing the inventive concept corresponding to each record. The present invention further includes: forming awareness databases including the fields of records from multiple awareness grids; forming new awareness grids by combining existing awareness grids, thus providing fertile ground for the inventive mind to create new inventive concepts; splitting awareness grids and recombining portions of them to augment gap analysis, again confronting the inventive mind with new creative possibilities; the awareness grids themselves; the awareness databases; and the use of awareness grids to analyze existing inventive concepts and create new inventive concepts.

A first aspect of the present invention relates to an awareness grid, wherein said awareness grid comprises:
(a) a set of grid dimensions;
(b) at least one grid record; and
(c) optionally, one or more ancillary categories,
wherein said set of grid dimensions is a set of concept dimensions capable of describing at least one inventive concept; and
wherein said grid record comprises:
   (i) a grid claimed field corresponding to each said grid dimension;
   (ii) a grid disclosed field corresponding to each said grid dimension; and
   (iii) optionally, one or more grid ancillary fields, each corresponding to a grid ancillary category.

A second aspect of the present invention relates to a method of building the awareness grid of the first aspect of the present invention, comprising the steps of:
(a) identifying a set of grid dimensions;
(b) forming one or more grid records, wherein said forming of said grid record comprises:
   (i) creating a grid claimed field corresponding to each said grid dimension;
   (ii) creating a grid disclosed field corresponding to each said grid dimension; and
   (iii) creating a grid ancillary fields corresponding to each said grid ancillary category.

A third aspect of the present invention relates to a method of building a synaptic grid, wherein said step of building said synaptic grid comprises:
(a) forming a union of the sets of grid dimensions of two or more remote grids;
(b) adding at least one grid record derived from each of said remote grids; and
(c) adding to each said grid record said grid claimed field, and said grid disclosed field for each said grid dimension of said synaptic grid which is not a member of said set of grid dimensions of said remote grid from which said grid record was taken;
wherein:
   two said awareness grids are said remote grids with respect to each other if said set of grid dimensions of one said awareness grid is not identical to said set of grid dimensions of the other said awareness grid, and neither of said sets of grid dimensions is a proper subset of the other.

A fourth aspect of the present invention relates to a method of splitting said awareness grid into two or more remote grids,
wherein:
   each said remote grid has said set of grid dimensions which is not identical to said set of grid dimensions of any of the other said remote grid, and is not a proper subset of said set of grid dimensions of any other said remote grid; and
   any grid record of said remote grid comprises a grid claimed field and a grid disclosed field corresponding to each said grid dimension of said remote grid.

The present invention further relates to a synaptic grid comprised of two or more remote grids, wherein said remote grids are awareness grids according to the first aspect of the present invention, and each said remote grid has a set of grid dimensions having at least one dimension which is not a member of said set of grid dimensions of any other said remote grid of said synaptic grid.

The present invention still further relates to an awareness grid which is an awareness database, or a synaptic grid, or a combination thereof.

### BRIEF DESCRIPTION OF THE DRAWINGS

FIG. 1 is a flowchart for a master routine for an overall process which includes forming, populating, expanding, and using awareness grids and awareness databases: to describe, categorize, compare and analyze inventive concepts: and to create new inventive concepts.

FIG. 2 is a flowchart for a subroutine for a process of initializing an awareness grid.

FIG. 3 is a flowchart for a subroutine for a process of assessing the need for adding new concept dimensions and ancillary categories to an existing awareness grid, and adding those new dimensions and ancillary categories based upon that assessment.

FIG. 4 is a flowchart for a subroutine for a process of initializing a grid record.

FIG. 5 is a flowchart for a subroutine for a process of populating a grid record.

FIG. 6 is a flowchart for a subroutine for a process of populating an ancillary field.

FIG. 7 is a flowchart for a subroutine for a process of populating a grid claimed field.

FIG. 8 is a flowchart for a subroutine for a process of populating a grid disclosed field.

FIG. 9 is a flowchart for a subroutine for a process of selecting inventive concepts for comparison.

FIG. 10 is a flowchart for a subroutine for a process of selecting values for analysis of first and second inventive concepts.

FIG. 11 is a flowchart for a subroutine for a process of determining novelty.

FIG. 12 is a flowchart for a subroutine for a process of determining obviousness.

FIG. 13 is a flowchart for a subroutine for a process of determining right to practice.

FIG. 14 is a flowchart for a subroutine for a process of initializing and/or expanding an awareness database.

FIG. 15 is a flowchart for a subroutine for a process of adding all or part of a grid record to an awareness database.

FIG. 16 is a flowchart for a subroutine for a process of building a synaptic grid.

FIG. 17 is a flowchart for a subroutine for a process of calculating synaptic grid characteristics.

FIG. 18 is a flowchart for a subroutine for a process of forming a synaptic concept.

FIG. 19 is a flowchart for a subroutine for a process of splitting an awareness grid.

FIG. 20 is a flowchart for a subroutine for a process of analyzing for gaps.

Used herein, the following terms have these definitions:

“Range”. Disclosures of ranges herein take the form of lower and upper limits. There may be one or more lower limits and, independently, one or more upper limits. A given range is defined by selecting one lower limit and one upper limit. The selected lower and upper limits then define the boundaries of that particular range. All ranges that can be defined in this way are inclusive and combinable, meaning that any lower limit may be combined with any upper limit to delineate a range.

An “inventive concept” is a concept for an invention, wherein the inventive concept is describable in terms of “concept dimensions”.

A “concept dimension” of an inventive concept is a parameter of an inventive concept such that the inventive concept can be described according to one or more of its “concept dimensions”. A “concept dimension value” is an actual value describing a concept dimension of an inventive concept. A single concept dimension may be assigned a single concept dimension value or multiple concept dimension values. Concept dimension values may be expressed, for example, as one or more ranges of values, or as one or more sets of discrete values. A concept dimension value may further be quantitative, qualitative, or some combination of quantitative and qualitative. When there are ranges of concept dimension values, those ranges my be continuous or discontinuous. The following example illustrates the meaning of “concept dimension” and “concept dimension value”. Inventive concept X for a ‘stool for sitting’ could be described in terms of the following “concept dimensions”: seat composition; seat shape; seat height from floor; leg composition; and leg number. If the seat composition describing inventive concept X can be oak, maple, pine, aluminum, or composite board, then oak, maple, pine, aluminum, or composite board are members of a set of “concept dimension values” of the ‘seat composition’ dimension for inventive concept X. If the concept dimension ‘seat height from floor’ of inventive concept X is described as being no less than 50 centimeters and no more than 150 centimeters, then the range 50 to 150 centimeters is a range of the concept dimension values for the dimension ‘seat height from floor’ of inventive concept X. If the same concept dimension ‘seat height from floor’ is also describe as being no less than 75 centimeters and no more than 125 centimeters, then the range 75 to 125 centimeters is another range of the concept dimension values for the concept dimension ‘seat height from floor’. Although no particular limit is placed on the minimum number of concept dimensions, the concept dimension values of which are capable of describing an inventive concept, typically an inventive concept is described in terms of plural concept dimensions. The number of concept dimensions by which a given inventive concept can be described is: no fewer than 1 concept dimension, no fewer than 2 concept dimensions, no fewer than 3 concept dimensions, or no fewer than 5 concept dimensions; no more than 100 concept dimensions, no more than 30 concept dimensions, no more than 20 concept dimensions, no more than 10 concept dimensions, or no more than 5 concept dimensions. It is further recognized that, if it is necessary to describe a given inventive concept in terms of more than 100 dimensions, all of those dimensions could be accommodated by the awareness grid of the present invention because there is no particular limit to the number of dimensions that can be contained in an awareness grid.

Two “inventive concepts” are “intersecting inventive concepts” if a set of concept dimensions according to which one of the inventive concepts can be described interests with a set of concept dimensions according to which the other of the two inventive concepts can be described.

The term “record” has its usual meaning in database technology. A “record” is a set of related “fields”, wherein those fields are designed to contain data related to the subject matter designated to be contained in that record. In the present invention, the fields of a given record are related in that they are capable of containing data describing concept dimensions of an inventive concept contained in a “source”, as well as data describing the source itself. A “field” is then a “location in memory” capable of storing data, and from which data can be retrieved. It is understood that a “location in memory” can be a place or places in any type of accessible computer memory. A “location in memory” may also be a cell of information in a handwritten, or otherwise affixed, table (or other arrangement) of related information set forth on any sort of medium, including, for example, paper. Typically, the data input to any given field of a given record provide information related to the source described in that record, as well as an inventive concept described in that source.

A “source” of information regarding an inventive concept describable in a “record” of the present invention, includes, but is not limited to: patent; published or unpublished patent application; file wrapper from the United States Patent and Trademark office, or other patent office; open literature document, including journal article, book, abstract of a presentation, academic thesis, handbook, manual, workbook, magazine, pamphlet, newspaper, or advertising flyer; communication from one or more inventors; an inventor's notes containing description of an inventive concept; notes on a presentation; description of observations regarding compositions, processes, uses, articles, or devices, or combinations thereof; information obtained from a commercial or private database; and any other description of an inventive concept. It is, of course, the case that a single source may contain information regarding a single inventive concept, or more than one inventive concept. When more than one inventive concept described in a single source is to be described in an awareness grid, it may often be desirable to create an awareness record for each inventive concept.

An “awareness record” includes a set of “disclosed fields” and “claimed fields”, and, optionally, “ancillary fields”. database record remote record

A “disclosed field” is a field of an awareness record, wherein that field is designated to contain “disclosed dimension values” describing what the source of the inventive concept described in that awareness record discloses about a dimension of that inventive concept. When that source discloses information about a concept dimension of that inventive concept, and that concept dimension is a member of the set of grid dimensions of the awareness grid, one or more “disclosed dimension values” describing that information should be entered into the corresponding disclosed field of that record. When that source discloses no information about a grid dimension, the corresponding disclosed field may be left empty, or a disclosed dimension value, indicating that no information regarding that dimension is disclosed, may be entered.

A “claimed field” is a field of an awareness record, wherein that field is designated to contain “claimed dimension values” describing what the source (here, a patent or patent application, or related document) of the inventive concept described in that awareness record claims about a concept dimension of that inventive concept. When that source has one or more claims directed to a concept dimension of that inventive concept, and that concept dimension is a member of the set of grid dimensions of the awareness grid, one or more “claimed dimension values” describing that information should be entered into the corresponding claimed field of that record. When that source claims nothing about a grid dimension, the corresponding claimed field may be left empty, or a claimed dimension value, indicating that nothing is claimed regarding that grid dimension, may be entered.

An “ancillary field” is a field of an awareness record designated to contain “ancillary values” describing any characteristics of a source corresponding to that awareness record, wherein those characteristics may include metadata about the source including, for example: journal name, volume number, issue number, author name, institution name, publication date; patent number, patent application number, inventor name, assignee name, priority date, filing date, publication date, expiration date; accession number; other sorting categories; links to databases, for example, but not limited to, databases containing the full text, some portion (e.g., claims, abstracts, summaries) of patents, patent applications, or open literature sources, databases containing information regarding relationships among sources (e.g., citation databases, including those having associated analytical capability); links to electronic files and folders containing information related to the source, for example, the electronic file wrapper for prosecution of a patent at the United States Patent and Trademark Office, or other patent office; patent databases, journal database; legal status; and notes and comments; and links to audio, visual, or audio-visual presentations describing the inventive concept. An “ancillary field” may further be a field designated to contain information: summarizing aspects of the inventive concept described in a record (e.g., notes and comments); or enhancing the sorting of records. Ancillary fields, therefore, may contain “ancillary tags” (e.g., patent number, accession number, assignee name, inventor name); “ancillary links” (e.g., links to databases or files located anywhere, including links to internet or intranet addresses); or comments (e.g., notes referring to some aspect, or aspects, of a particular source or the information contained therein).

“claimed dimension values”, “disclosed dimension values”, and “ancillary values” are referred to collectively, herein, as “awareness values”.

An “awareness grid” is a data structure including a set of one or more “grid dimensions”, wherein those “grid dimensions” are “concept dimensions” capable of describing at least one inventive concept. Further, an “awareness grid” includes at least one “grid record”.

A “grid record” is an record including a “grid disclosed field” and a “grid claimed field” corresponding to each grid dimension of the awareness grid that includes that grid record. A “grid record”, optionally includes one or more “ancillary fields”. The capacity of an awareness grid to provide a solid basis for decisions regarding both patentability and practicability derives from the presence of both a claimed field and a disclosed field for corresponding to each dimension of each record of an awareness grid.

An inventive concept disclosed in, or by, a source is suitable for being described in a grid record of a given awareness grid if a set of concept dimensions capable of describing that inventive concept intersects with the set of grid dimensions of that awareness grid.

To “populate a field” of a grid record is to place one or more awareness values into that field. To “populate a record” is to place one or more awareness values into at least one field of that record.

The terms “grid dimension”, “grid record”, “grid source”, “grid field”, “grid claimed field”, “grid disclosed field”, and “grid ancillary field” are examples of phrases in which the word “grid” is used to designate that a particular awareness grid includes, respectively, that “dimension”, “awareness record”, “source”, “field”, “claimed field”, “disclosed field”, or “ancillary field”. A “grid inventive concept” is an inventive concept capable of description according to a set of concept dimensions which intersects with the set of grid dimensions of a given awareness grid, and which is described in a grid record of that awareness grid.

A “first inventive concept” may be “patentable” with regard to a “second inventive concept”, or second inventive concepts, contained in a source, or sources, if that first inventive concept, described in one or more claims, whether informally or formally written and whether, or not, incorporated into a formal patent application or patent, is: (a) novel when compared with the disclosed second inventive concepts, taken one at a time; and (b) non-obvious when compared with second inventive concepts, taken one at a time, or taken as a whole when a group of two or more is considered.

A specific embodiment of an inventive concept for a composition, method of manufacture, method of using, device, or article may be “practicable” (i.e., a right to practice exists) with regard to a claim of a given in force patent if that specific embodiment does not fall within a claim of that in force patent, and if that in force patent is held by another (e.g., a specific embodiment is contemplated for commercialization by one company, but an in force patent having a claim encompassing that specific embodiment is held by another separate company). A patent is in force if that patent has issued and has not expired, nor been abandoned, nor been invalidated.

The laws, rules, and judicial interpretations regarding patentability and practicability (i.e., right to practice) of countries other than the United States of America (herein, alternatively, United States or U.S.) may differ from those of the United States of America. Further, the laws, rules, and judicial interpretations regarding patentability and practicability are subject to change with time in the U.S. and other countries. The present invention recognizes that successful analysis of an inventive concept to determine its patentability and practicability depends upon the skill of the intellectual property practitioner (e.g., patent attorneys, patent agents, and patent examiners) in making such analysis in the context of fluid, time-dependent, and country-dependent laws, rules, and judicial interpretation. Therefore, the present invention has great utility in that the awareness grids, awareness databases, and the methods of using them for analysis and for inventing are robust in the face of those changes.

The concepts and terminology of “set theory”, as described in Introduction to Number Systems, G. A. Spooner and R. L. Mentzer, 1968, pp. 7-42, Prentice-Hall, Inc., Englewood Cliffs, N.J., are used herein to describe aspects of awareness grids and manipulation of awareness grids. The following definitions and symbols, standard in set theory, are used herein.

A “set” contains “members”. For example, a set of colors might contain red, blue, and green, in which case red, blue, and green are said to be members of that particular set. An “awareness grid” includes a “set” containing “dimensions” as “members” of that “set”. A given awareness grid can be described, for example, as including a “set of grid dimensions”.

Brackets are used to denote a set, wherein the members of that set are contained within the brackets. For example, if an awareness grid includes grid dimensions a, b, c, d, and e, as members, those grid dimensions may be described as set A, wherein A={a, b, c, d, e}. That is, the set of grid dimensions denoted as set A contains 5 grid dimensions as members.

A “null set” is a set containing no members. A null set is, therefore, an empty set. The symbol “Ø” indicates that a given set is a “null set”. For example, the expression B=Ø indicates that set B has no members and is, by definition, a null set. Another designation for a null set is empty brackets: { }=Ø.

The symbol “ε” means “is a member of set”. For example, “rεK”, means that “r is a member of set K”. If a given awareness grid includes set A containing grid dimensions a, b, c, d, and e as members, then A={a, b, c, d, e}, and: aεA, bεA, cεA, dεA, and eεA.

A set may contain subsets. If a set is a subset of another set, this relationship is indicated by the symbol “⊂”. For example B⊂A means that set B is a subset of set A. If A={a, b, c, d, e} and B={b, c, d}, then any of these equivalent expressions indicates that set B is a subset of set A: B⊂A; {b, c, d}⊂{a, b, c, d, e}; B⊂{a, b, c, d, e}; or {b, c, d}⊂A. Every set is a subset of itself. Therefore, A⊂A in this example. That is, {a, b, c, d, e}⊂{a, b, c, d, e}. The null set is a subset of every set. Therefore, in this example, any of these expressions indicates that the null set is a subset of set A: Ø⊂A; { }⊂{a, b, c, d, e}; { }⊂A; or Ø⊂{a, b, c, d, e}.

A “proper subset” is any subset that does not include all of the members of the set of which it is a subset. If a set is a proper subset of another set, this relationship is indicated by the symbol “⊂”. Consider the example in which A={a, b, c, d, e}, B={a, b, c}, C={c, d, e}, and D={ }=Ø. In this example, sets B, C, and D are proper subsets of set A, but set A is not a proper subset of itself. Therefore: B⊂A; C⊂A; and D⊂A, but it is not true that A⊂A, i.e., AA.

The sum of all unique subsets of a given set (i.e., the set and any proper subsets) is equal to 2ⁿ, wherein “n” equals the number of members of the set. If a given set has 5 members, then n=5, and there will be 2⁵=32 unique subsets (including the set itself and the null set) contained in that given set of 5. Consider the following example in which n=3. Set A, the “full set”, is described as: A={a, b, c}, then the number of subsets of set A is: the null set { }; sets containing just one member {a}, {b}, and {c}; sets containing two members {a, b}, {a, c}, and {b, c}; and the full set {a, b, c}. The total number of unique sets for a given set A having three members (n=3) is, therefore, 2³=8 unique subsets. Note that the subset {b, a} is also a subset of {a, b, c}. However, because {a, b} is identical to {b, a}, only one of the these two subsets is listed to denote the unique set containing both member a and member b. The equality {a, b}={b, a} is another way of expressing that {a, b} is identical to {b, a}.

The n members of a full set (i.e., the set containing all n members, and no more) may be combined by “member incremented pairwise union” to form that full set. Herein, “member incremented pairwise union” is the process of forming the union of a single member with another single member, or forming the union of a set containing two or more members with a single additional member. A set formed by “member incremented pairwise union”, then, contains one more member than the largest set upon which that member incremented pairwise union was performed. The full set having n members may be built by the process of member incremented pairwise union, starting with any single member selected from those n members. Starting with a single member, the process of member incremented pairwise union builds a series of subsets, each having one more member than the preceding subset, until all members have been added, and the full set has been formed. The number of unique subsets, having at least two members, that can be formed by such “member incremented pairwise union” is given by the expression: 2ⁿ−n−1. If n members are to be combined by “member incremented pairwise union” to form the full set containing all of those n members (and no more), and n=5, then 2ⁿ−n−1=2⁵−5−1=32−5−1=26 is the number of unique subsets having at least two members, including the full set but excluding the null set, that can be formed by “member incremented pairwise union”. In like manner, the number of unique proper subsets, having at least two members, of a full set containing n members that can be formed by member incremented pairwise union is given by the expression 2ⁿ−n−2 (wherein subtraction of the number “2” accomplishes exclusion of the full set and the null set, and subtraction of the number “n” accomplishes exclusion of all sets having a single member). If n members are to be combined by “member incremented pairwise union” to form the full set containing all of those n members (and no more), and n=5, then 2ⁿ−n−2=2⁵−5−2=32−5−2=25 is the number of unique proper subsets having at least two members (i.e., excluding the subsets containing a single member, the full set, and the null set) that can be formed by “member incremented pairwise union”. Consider the following example in which n=3. Set A, the “full set”, is described as: A={a, b, c}, then the number of unique proper subsets of set A is: the null set { }; sets containing just one member {a}, {b}, and {c}; and sets containing two members {a, b}, {a, c}, and {b, c}. If sets {a}, {b}, {c} and { } are further excluded, the total number of unique proper subsets, having at least two members, for a given set A having three members (n=3) becomes {a, b}, {a, c}, and {b, c}, a total of 2³−3−2=8−3−2=3.

When the union of two sets is formed, the union set is the set containing all of the members from both sets, i.e., the union set formed by that process of union is the “union of the two sets”. The symbol for union is “∪”. For example, when set A={a, b, c} and set B={d, e, f}, and set A and set B are merged to form set C={a, b, c, d, e, f}, the process of union is shown as follows: A∪B=C; or {a, b, c}∪{d, e, f}={a, b, c, d, e, f}.

As just illustrated, two sets having no members in common, referred to as “disjoint” sets, may form a union. It is also possible for a union to be made between two sets having one or more members in common. For example, when set A={a, b, c} and set B={b, c, d, e}, and set A and set B are merged to form set C={a, b, c, d, e}, the process of union results in set C having members (here b and c) derived from both set A and set B. That is, {a, b, c}∪{b, c, d, e}={a, b, c, d, e}.

When the union of two sets is formed, and one or more members of those two sets are common to both of those sets, the subset of that union which contains only those common members is referred to as the “intersection” of the two sets. For example, when set A={a, b, c} is merged with set B={b, c, d, e} to from the union set C={a, b, c, d, e}, the “intersection” of sets A and B is described by the expression A∩B={b, c}. The symbol for intersection is “∩”, and “A∩B={b, c}” can be read as “the intersection of set A and set B is a set containing the members b and c”. It will be recognized that the intersection of two sets having no members in common is a null set. For example, {a, b, c}∩{d, e, f}=Ø. Two sets having no members in common are said to be “disjoint” sets.

Just as it is possible to build a full set from its members by “member incremented pairwise union”, it is also possible to build a full set by “subset incremented pairwise union”. Herein, “subset incremented pairwise union” is the process of forming the union of a subset, of a given full set, with another non-identical subset of that full set. A subset formed by “subset incremented pairwise union”, then, contains all of the members, both common and non-common, of the two subsets from which it was formed. “Member incremented pairwase union” is a special case of a “subset incremental pairwise union” in which one of the subsets combined has a single member.

When, in set theory, any given set is discussed, it is understood that the given set exists in relationship to some reference set called the “universal set”. For example, the set of all family names of residents of Bangor, Me. is a subset of a universal set of all family names of residents of the world. It is further understood that there may be more than one universal set containing a given set. In this case, another universal set is a set of all family names of residents of the United States of America.

An “awareness database” includes a universal set of concept dimensions, referred to as “awareness database dimensions”. A set of grid dimensions, of a given awareness grid, having one or more grid dimensions in common with the set of awareness database dimensions of an awareness database is said to intersect with that set of awareness database dimensions of the awareness database. That set of grid dimensions may be identical to the set of awareness database dimensions, or a proper subset, or an intersecting set having one or more grid dimensions not common to the set of awareness database dimensions. There may exist multiple “awareness databases”, wherein the set of awareness database dimensions of any one of those awareness databases may be identical to, intersect with, be a proper subset of, contain as a proper subset, or be disjoint with respect to the set of awareness database dimensions of any of the other of those multiple awareness databases.

An “awareness database” further includes one or more “awareness database records”. An “awareness database record” includes a “disclosed field” and “claimed field” corresponding to each member of the set of awareness database dimensions included in that awareness database. An “awareness database” may, optionally, also include one or more “ancillary fields”.

An inventive concept described in, or by, a source is suitable for being described in a grid record of a given awareness grid if a set of concept dimensions capable of describing that inventive concept intersects with the set of grid dimensions of that awareness grid.

An inventive concept described in, or by, a source is suitable for being described in an awareness database record of a given awareness database if a set of concept dimensions capable of describing that inventive concept intersects with the set of awareness database dimensions of that awareness grid.

An awareness grid may be expanded by, for example, adding additional concept dimensions, ancillary categories, or records. An awareness database may be expanded by, for example, adding additional concept dimensions, ancillary categories, or records.

The terms “awareness database dimension”, “awareness database record”, “awareness database source”, “awareness database field”, “awareness database claimed field”, “awareness database disclosed field”, and “awareness database ancillary field” are examples of phrases in which the word “awareness database” is used to designate that a particular awareness database includes, respectively, that “dimension”, “awareness record”, “source”, “field”, “claimed field”, “disclosed field”, or “ancillary field”. An “awareness database inventive concept” is an inventive concept capable of description according to a set of concept dimensions which intersects with the set of awareness database dimensions of a given awareness database, and which is described in an awareness database record of that awareness database.

“Awareness database values” contained in any of the “awareness database disclosed fields”, “awareness database claimed fields”, and “awareness database ancillary fields” (referred to collectively as “awareness database fields”) of a given awareness database record of a given awareness database may be used to populate, respectively, any grid disclosed fields, grid claimed fields, or grid ancillary fields (referred to collectively as “grid fields”) of a given grid record of a given awareness grid, provided that: the awareness database source corresponding to that awareness database record is the same as the grid source corresponding to that grid record; and the grid field of the grid record that is to be populated corresponds to the awareness database field from which the awareness database value was obtained. Single grid fields or multiple grid fields of a grid record of an awareness grid may be populated in this way.

The ability to provide access to awareness database values contained in awareness database records of an awareness database, wherein those data are selected according to a set of criteria, finds commercial utility. For example, customers could purchase access (e.g., viewing, copying, or viewing and copying) to the data of an awareness database. A customer having been granted the right to copy data from a given awareness database, could, for example, utilize such data to form an “in-house” awareness grid or multiple “in-house” awareness grids, or even an “in-house” awareness database. Although access to data contained in an awareness database may be offered for sale and sold, it is recognized that the database records, or one or more database fields of those database records, may be made available free of charge, or on a quid pro quo basis. For example, an industrial or academic entity may maintain one or more awareness databases, the awareness records of which could be made available to interested parties within that entity, or external to that entity. One skilled in the art of database management will, of course, recognize that it is possible to devise addressing schemes allowing the records of an awareness grid, physically resident on an awareness database, to be addressed as if those awareness records were physically separate from other records on the awareness database that are not part of that awareness grid. Under such conditions, a desired awareness grid can be accessed during a user session without ever being downloaded. In addition, access to, for example, selected fields or records of an awareness database can be granted to a specific user, while excluding access to other fields and records of that awareness database.

There are no particular constraints on how awareness values designated to populate awareness database fields and awareness database records, or grid fields and grid records are stored in computer hardware memory. However, for convenience and clarity of description, herein, an awareness database is described as if it has a physical hardware memory location for every possible database field, or every possible grid field, respectively of every database record of an awareness database or grid record of an awareness grid, whether or not that field has been populated with any data. Under this simplifying formalism, for example, an awareness database containing 100 database dimensions, each database dimension described by a database disclosed field and a database claimed field, and each of these fields corresponding to one unique memory location (address), would have 200 hardware memory locations corresponding to 100 claimed fields and 100 disclosed fields for every database record. This would be true even for a database record directed at an inventive concept describable in terms of only 5 of those 100 dimensions. For that record, the maximum number of fields that could be populated with data would be: 10 if the source was a patent (5 for information claimed regarding the 5 dimensions; and 5 for information disclosed regarding the same 5 dimensions); or 5 if the source was from the open literature (i.e., having no claims to describe). Of course, there would likely be plural ancillary fields as well, each of which might, or might not, be populated. One of ordinary skill in the art of database management will recognize that, for the sake of efficiency, hardware and software architecture may be designed in such a way that an actual physical location in memory corresponding to a particular field is assigned only when data to populate that particular field exist and require entry into memory. It is further understood that data populating a given field may exist at a single physical location in hardware memory, or that it may be exist wholly, or partially, in plural physical locations in hardware memory.

Two awareness grids are “remote grids” with respect to each other if the set of grid dimensions of one is not identical to the set of grid dimensions of the other, and neither of the sets of grid dimensions is a proper subset of the other, i.e., each of the two sets of grid dimensions has at least one grid dimension not common to the other set.

A “synaptic grid” is a special case of an “awareness grid”. A “synaptic grid” is formed by: (a) forming the union of the sets of grid dimensions for two or more remote grids; (b) adding at least one grid record derived from each of those remote grids; and (c) for each grid record added to the synaptic grid, adding a grid claimed field, and a grid disclosed field for each grid dimension of the synaptic grid which was not a member of the set of grid dimensions included in the remote grid from which that grid record was derived. Typically one or more of the ancillary categories of each remote grid will be included in the synaptic grid. For each grid record added to the synaptic grid, an ancillary field is added for each ancillary category which was not an ancillary category of the remote grid from which that grid record was derived.

A “grid pair intersection value” for a pair of remote grids is a value calculated by: (a) determining the number of members of the grid dimension union set for the union of the set of grid dimensions contained in one of the remote grids with the set of grid dimensions contained in the other of the remote grids; (b) determine the number of members of the intersection set of that union set; and (c) divide the number of members of the intersection set by the number of members of the union set to yield a result, wherein that result is the “grid pair intersection value” for the pair of remote grids. If, for example, a remote grid A contains a set of grid dimensions a, b, c, and d, and remote grid B contains a set of grid dimensions c, d, e, and f, the “grid pair intersection value” for union of those two sets of grid dimensions equals [2/(2+4)]=[2/6] 0.333.

The “grand intersection value” for a synaptic awareness grid produced by merging two or more remote grids (which includes forming the union of the sets of grid dimensions of those remote grids) is a value determined by: (i) calculating the grid pair intersection value for every unique pairwise union of remote grids that can be used to form the synaptic grid; (ii) summing the grid pair intersection values for all unique pairwise unions of remote grids that can be used to form the synaptic grid, to yield a “grid pair intersection value sum”; and (iii) dividing that grid pair intersection value sum by the total number of unique “pairwise unions” of remote grids that can be used to form the synaptic grid, to yield the “grand intersection value” for the synaptic grid.

As an illustrative example, consider three remote grids. Remote grid A contains three grid dimensions, a, b, and c, and can, therefore, be represented as follows: A={a, b, c}. In like manner, remote grid B contains grid dimensions b, c, and d, and is represented as: B={b, c, d}. Similarly, remote grid C contains grid dimensions d, e, and f, and is represented as: C={d, e, f}. Table I shows the unique pairwise unions of the sets of grid dimensions of the remote grids that can form synaptic grid ABC, and the calculations of “grid pair intersection values” and “grid pair tilt angles” for unique pairwise unions of remote grids with remote grids. In addition, calculations of the “grand intersection value” and the “grand tilt angle” for the synaptic grid formed from remote grids A, B, and C are also shown.

When three or more remote grids are combined by pairwise union to form a synaptic grid, “intermediate grids” will be formed, each of which is itself a synaptic grid. For example, if remote grids A and B are “pairwise merged” to form grid AB, and grid AB is then pairwise merged with remote grid C to for synaptic grid ABC, then grid AB is an “intermediate grid” in the process of forming synaptic grid ABC. Similarly, in Table I, grids AC and BC are also “intermediate grids” in the process of forming synaptic grid ABC. It should further be noted that intermediate grids AB, AC, and BC may also be considered to be synaptic grids resulting from the pairwise merger of A+B, A+C, and B+C, respectively. It should still further be noted that intermediate grids AB, AC, and BC may also be considered to be remote grids in the process of union with remote grids C, B, and A, respectively, to form the ultimate synaptic grid ABC. It will be understood, then, that when three or more remote grids are being pairwise merged to form a synaptic grid, the term “pairwise union of remote grids” includes: pairwise union of initial remote grids; pairwise union of an intial remote grid with an intermediate grid; and pairwise union of two intermediate grids.

TABLE I
Determination of the grand intersection value and the grand tilt angle for a synaptic awareness
grid formed from three remote grids by unique pairwise union of those remote grids.

| Pairwise | | | | | | |
|---|---|---|---|---|---|---|
| Union of | | | | | Grid Pair Intersection | |
| Remote | Sets of Dimensions involved | | Synaptic grids formed by | | Value for the Pairwise | Grid Pair Tilt Angle for the |
| Grids | in the Pairwise Union | | Pairwise Union of Remote Grids | | Union of Remote Grids | Pairwise Union of Remote Grids |
| A ∪ B | {a, b, c} ∪ | {b, c, d} | AB = | {a, b, c, d} | 2/4 = 0.500 | (1 − .500)*90° = 45° |
| AB ∪ C | {a, b, c, d} ∪ | {d, e, f} | ABC = | {a, b, c, d, e, f} | 1/6 = 0.167 | (1 − .167)*90° = 75° |
| A ∪ C | {a, b, c} ∪ | {d, e, f} | AC = | {a, b, c, d, e, f} | 0/6 = 0.000 | (1 − 0)*90° = 90° |
| AC ∪ B | {a, b, c, d, e, f} ∪ | {b, c, d} | ACB = | {a, b, c, d, e, f} | 3/6 = 0.500 | (1 − .500)*90° = 45° |
| B ∪ C | {b, c, d} ∪ | {d, e, f} | BC = | {b, c, d, e, f} | 1/5 = 0.200 | (1 − .200)*90 = 72° |
| BC ∪ A | {b, c, d, e, f} ∪ | {a, b, c} | BCA = | {a, b, c, d, e, f} | 2/6 = 0.333 | (1 − .333)*90° = 60° |

| | | |
|---|---|---|
| sum of values for all unique pairwise unions | 1.700 | 387° |
| number of unique pairwise unions | 2n − 2 = 23 − 2 = 6 | 6 |
| grand values | 1.700/6 = 0.283 | 64.5° |

For any set of n remote grids used to form a synaptic grid, the number of unique pairwise unions, as illustrated in Table I, will be 2ⁿ−2. For the pairwise formation of a synaptic grid from 3, 4, 5, and 6 remote grids, the number of unique pairwise unions will be, respectively: 8−2=6; 16−2=14; 32−2=30; and 64−2=62.

A “grid pair tilt angle” for a pair of remote grids is a value calculated by: subtracting the grid pair intersection value for that pair of remote grids from 1 to produce a remainder; and multiplying that remainder by 90 degrees. For example, if the grid pair intersection value for a pair of remote grids is 0.333, the corresponding grid pair tilt angle equals (1−0.333)*90°=60°. (See the pairwise union of intermediate grid BC with remote grid A in Table I.)

The “grand tilt angle” for a synaptic awareness grid produced by pairwise union of two or more remote grids is a value determined by: calculating the grid pair tilt angle for each unique pairwise union of remote grids used to form the synaptic grid; summing those grid pair tilt angles to produce a “tilt angle sum”; and dividing that tilt angle sum by the total number of unique pairwise unions of remote grids, to produce a “grand tilt angle” for the synaptic grid. (See Table I). A “tilt angle” is an estimation of the extent to which merging of remote awareness grids to form a synaptic grid, and hence merging the technology areas represented by those remote grids, increases the size of the technology area represented by that synaptic grid beyond the technology area of a remote grid from which that synaptic grid was formed. A tilt of 0° would be calculated for two awareness grids that have identical sets of grid dimensions. Such a merging of awareness grids does not form a synaptic grid because the awareness grids are not remote with respect to one another. This merged grid encourages the inventive mind to stay within the original technology area, looking for incremental change. In a figurative sense, the inventors eyes are forward, looking out across familiar ground, without looking up. As the tilt angle increases, the inventive scope and possibilities increase as the inventive mind looks upward and outward, focusing now on the less familiar technology areas in which novel invention may more likely be found. Of course, it must be kept in mind that reasonable persons may differ somewhat on the selection of dimensions to include in a given awareness grid. As a result, a tilt angle should be viewed as an estimation of whether a particular synaptic grid encourages “in the box” inventive thought (i.e., low tilt angle for a “proximal synaptic grid”), far “out of the box” inventive thought (i.e., high tilt angle for a “distal synaptic grid”), or something in between (i.e., medium tilt angle for a “medial synaptic grid”).

A “nascent concept” is an inventive concept that can be defined by the dimensions common to a pair of remote grids used to form a synaptic grid. If more than two remote grids are used to form a synaptic grid, the dimensions common to any unique pair of remote grids (i.e., the set of dimensions that is the intersection of the two sets of grid dimensions for the remote grids) used to form that synaptic grid may be used to form a nascent concept (see the examples).

A “synaptic concept” may be formed from a nascent concept, itself formed from a single pair of remote grids, by adding one or more dimensions contained in one remote grid of the pair, but not common to both remote grids of that pair. When more than two remote grids are used to form a synaptic grid, a synaptic concept may further be formed from a nascent concept, itself formed from three or more unique pairs of remote grids, by adding to that nascent concept one or more dimensions, of one or more of the unique pairs of remote grids, not common to any of the unique pairs used to form that nascent concept.

To “split an awareness grid”, or “splitting an awareness grid”, is to separate an awareness grid into two or more remote grids, wherein: each remote grid has a set of grid dimensions which is not identical to the set of grid dimensions of any of the other remote grid, and is not a proper subset of any other remote grid; and any grid record of a remote grid comprises a grid claimed field and a grid disclosed field corresponding to each the grid dimension of said remote grid. After splitting an awareness grid into remote grids, those remote grids can be combined to build a synaptic grid, wherein the building of the synaptic grid comprises: (a) forming a union of the sets of grid dimensions of two or more said remote grids; (b) adding at least one grid record derived from each of the remote grids; and (c) adding to each grid record one grid claimed field, and one grid disclosed field for each grid dimension of the synaptic grid which was not a member of the set of grid dimensions included in the remote grid from which the grid record was taken, thereby forming a synaptic record.

“Gap analyzing” the awareness grid includes forming one or more synaptic concepts by: (i) adding a new synaptic record to the synaptic grid formed from the remote grids produced by splitting an awareness grid; (ii) populating the new synaptic record, wherein said populating comprises:
populating at least one claimed field corresponding to at least one member of a set of intersecting dimensions of the union of two or more said sets of remote dimensions to form the set of grid dimensions of the synaptic grid; and
populating at least one claimed field corresponding to at least one member of a set of grid dimensions which is disjoint with respect to the set of intersecting dimensions; and
   (iii) comparing the set of grid dimension values contained in the new synaptic record with the set of grid inventive concepts described in one or more of the grid records of the awareness grid for the purpose of making decisions regarding novelty, or obviousness, or right-to-practice of the synaptic concept compared to one or more the grid inventive concepts.

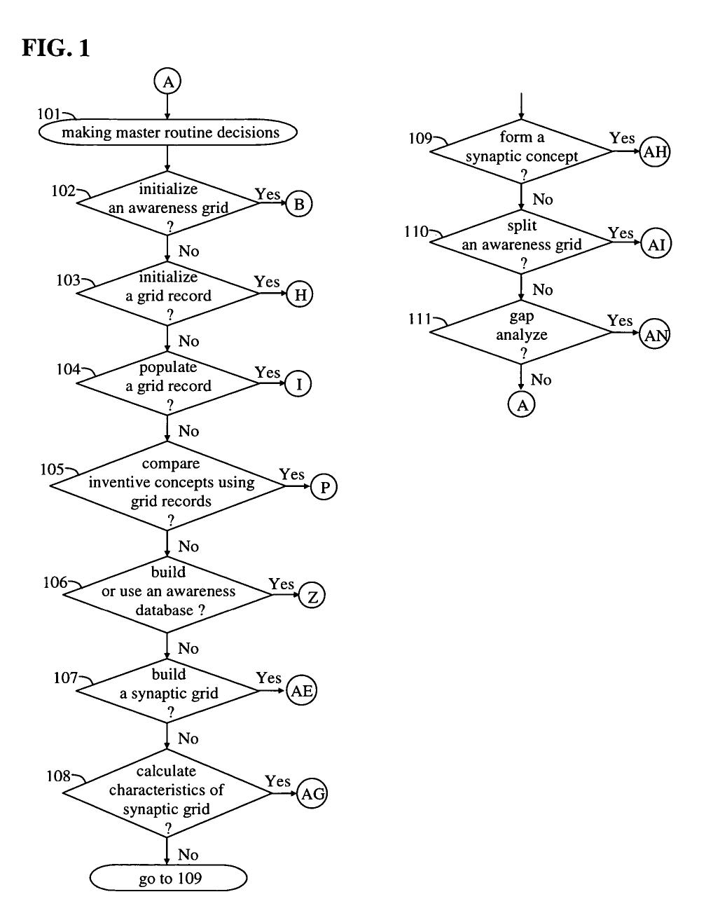

The embodiments of the present invention which follow are illustrated in terms of the decisions and actions described in the flowcharts of FIGS. 1 through 20. One of ordinary skill in the art of computer hardware design and computer software design will recognize that the decisions and operations set forth in the flowcharts of FIGS. 1-20 may be implemented using standard hardware architecture and standard programming techniques. Therefore, the decisions and actions of FIGS. 1-20 are set forth independent of any particular hardware or software architecture.

FIG. 1 shows a flowchart for a master routine 101 for an overall process which includes forming, populating, expanding, and using awareness grids and awareness databases to: describe, categorize, compare and analyze inventive concepts; and to create new inventive concepts. Decisions are made on whether to enter subroutines to: initialize an awareness grid 102; initialize a grid record 103; populate a grid record 104; compare inventive concepts using grid records 105; build or use an awareness database 106; build a synaptic grid 107; calculate characteristics of a synaptic grid 108; form a synaptic concept 109; split an awareness grid 110; or gap analyze 111. All decision subroutines return, at some point, to the master routine 101, so that, once exited, a decision subroutine may be reentered as appropriate.

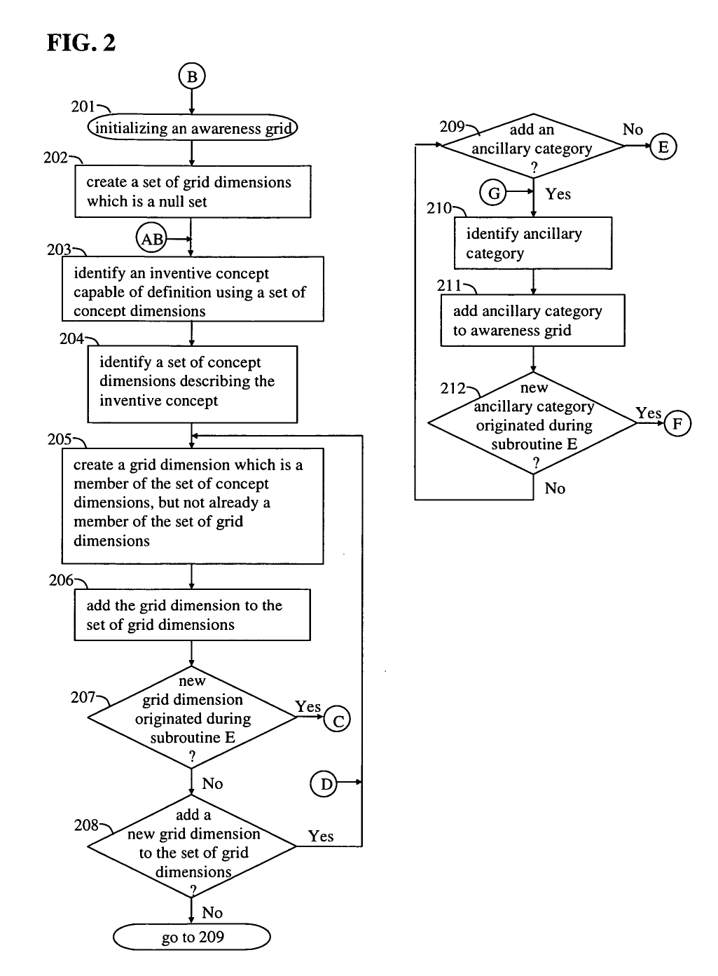

FIG. 2 shows a flowchart for a subroutine for a process of initializing an awareness grid 201 by: creating a set of grid dimensions which is a null set 202; identifying an inventive concept capable of definition using a set of concept dimensions 203; identifying a set of concept dimensions describing the inventive concept 204; creating a grid dimension which is a member of the set of concept dimensions, but not already a member of the set of grid dimensions 205; adding the grid dimension to the set of grid dimensions 206; deciding whether the new grid dimension originated during steps of populating 207, branching to step 305 if “Yes”, or continuing if “No”; deciding whether to add another new grid dimension to the set of grid dimensions 208, branching to step 205 if “Yes”, or continuing if “No”; deciding whether to add an ancillary category to the awareness grid 209, branching to the subroutine for adding concept dimensions and ancillary categories to an awareness grid 301 if “No”, or continuing if “Yes”; identifying an ancillary category 210; adding the ancillary category to the awareness grid 211; deciding whether the ancillary category originated during steps of populating 212, branching to step 307 if “Yes”, or branching to step 209 if “No”.

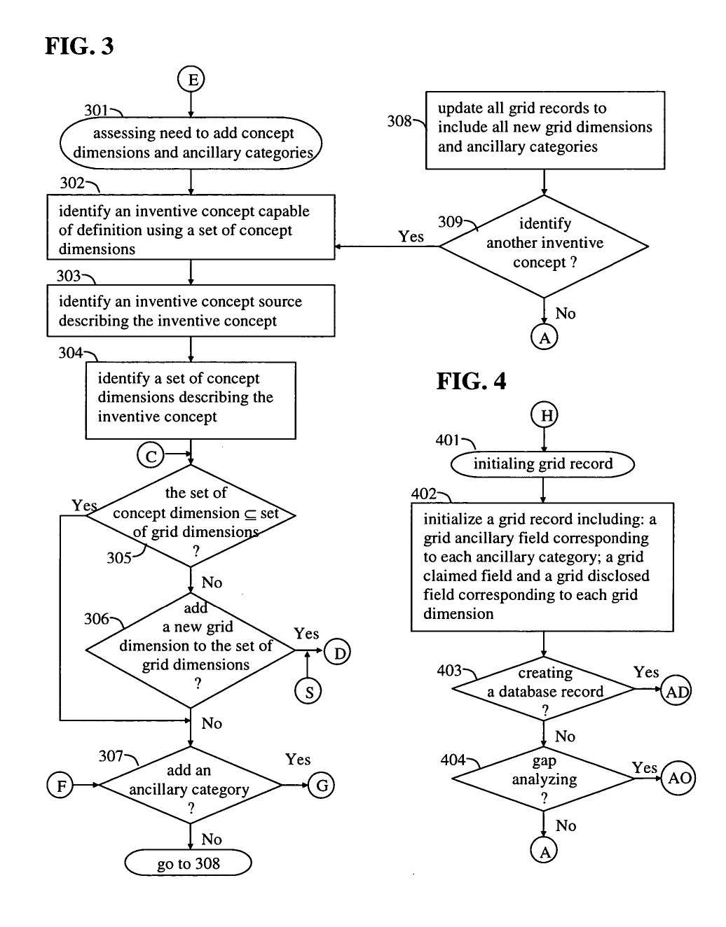

FIG. 3 shows a flowchart for a subroutine for a process of assessing the need for adding new dimensions and ancillary categories to an existing awareness grid, and adding those new dimensions and ancillary categories based upon that assessment 301 by: identifying an inventive concept capable of definition using a set of concept dimensions 302; identifying an inventive concept source describing the inventive concept 303; identifying a set of concept dimensions describing the inventive concept 304; deciding whether the set of concept dimensions ⊂ the set of grid dimensions 305, branching to step 307 if “Yes”, continuing if “No”; deciding whether to add a new grid dimension to the set of grid dimensions 306, branching to step 205 if “Yes”, continuing if “No”; deciding whether to add an ancillary category 307, branching to step 210 if “Yes”, continuing if “No”; updating all grid records to include all new grid dimensions and ancillary categories 308; deciding whether to identify another inventive concept 309, branching to step 302 if “Yes”, returning to the master routine 101 if “No”.

FIG 4 shows a flowchart for a subroutine for a process of initializing a grid record 401 by: initializing a grid record including a grid ancillary field corresponding to each ancillary category, a grid claimed field and a grid disclosed field for each grid dimension 402; and deciding whether to create a database record 403, branching to step 1409 if “Yes”, continuing if “No”; deciding whether the record is being initialized during the process of gap analyzing 2001, branching to the subroutine for gap analyzing at step 2005 if “Yes”, returning to the master routine at step 101 if “No”.

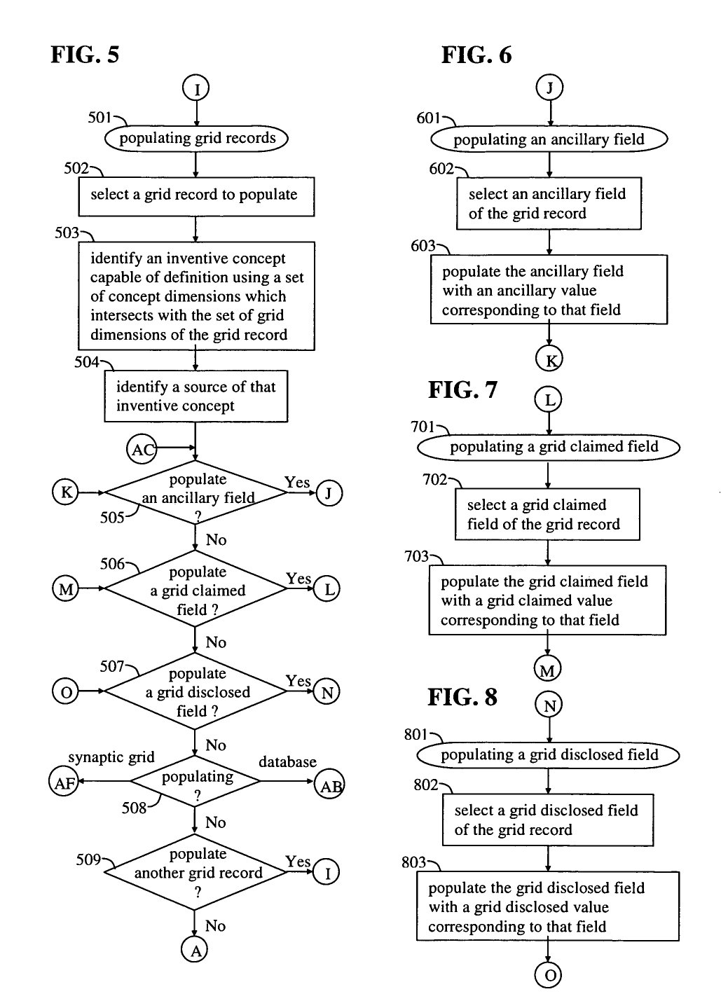

FIG. 5 shows a flowchart for a subroutine for a process of populating a grid record 501 by: selecting a grid record to populate 502; identifying an inventive concept capable of definition using a set of concept dimensions which intersects with the set or grid dimensions of the grid record 503; identifying a source of that inventive concept 504; deciding whether to populate an ancillary field 505, branching to step 601 if “Yes”, continuing if “No”; deciding whether to populate a grid claimed field 506, branching to step 701 if “Yes”, continuing if “No”; deciding whether to populate a grid disclosed field 507, branching to step 801 if “Yes”, continuing if “No”; deciding whether to populate at database or a synaptic grid 508, branching to step 1408 to populate a database, branching to step 1608 to populate a synaptic grid, and continuing if “No”; deciding whether to populate another grid record 509, branching to the start of the subroutine for populating grid records 501 if “Yes”, or returning to the master routine 101.

FIG. 6 shows a flowchart for a subroutine for a process of populating an ancillary field 601 by: selecting an ancillary field of a grid record 602; populating the ancillary field with an ancillary value corresponding to that ancillary field 603; and returning to the subroutine for populating grid records 501 at step 505.

FIG. 7 shows a flowchart for a subroutine for a process of populating a grid claimed field 701 by: selecting a grid claimed field of a grid record 702; populating the grid claimed field with a grid claimed value corresponding to that grid claimed field 703; and returning to the subroutine for populating grid records at step 506.

FIG. 8 shows a flowchart for a subroutine for a process of populating a grid disclosed field 801 by: selecting a grid disclosed field of a grid record 802; populating the grid disclosed field with a grid disclosed value corresponding to that grid disclosed field 803; and returning to the subroutine for populating grid record at step 507.

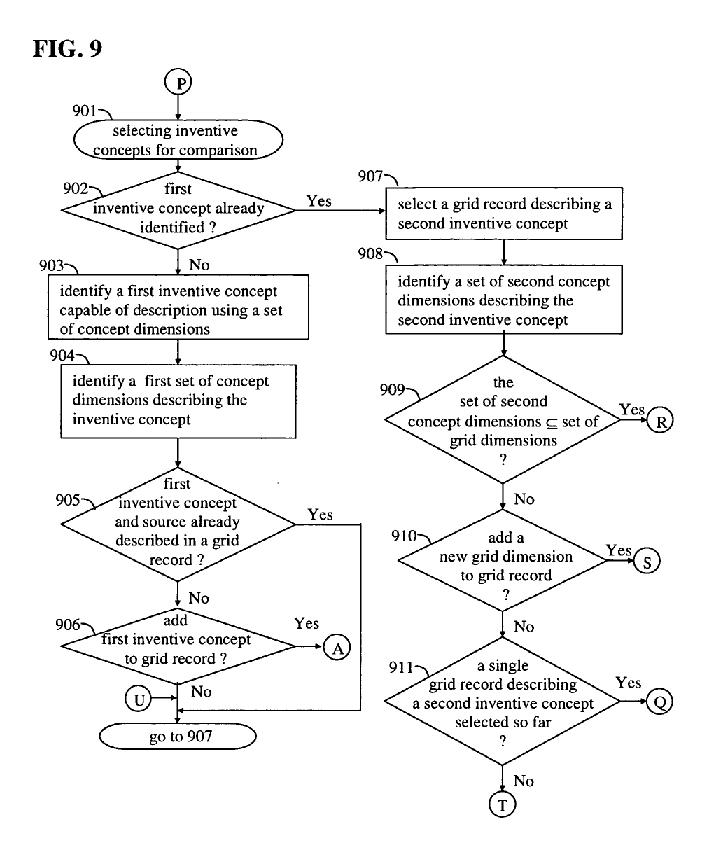

FIG. 9 shows a flowchart for a subroutine for a process of selecting inventive concepts for comparison 901 by: deciding whether a first inventive concept has already been identified 902, branching to step 907 if “Yes”, continuing if “No”; identifying a first inventive concept capable of description using a set of concept dimensions 903; identifying a first set of concept dimensions describing the inventive concept 904; deciding whether the first inventive concept and its source have already been described in a grid record 905, branching to step 907 if “Yes”, continuing if “No”; deciding whether to add the first inventive concept to a grid record 906, returning to the master routine 101 if “Yes”, continuing if “No”; selecting a grid record describing a second inventive concept 907; identifying a set of second concept dimensions describing the second inventive concept 908; deciding whether the set of second concept dimensions C the set of grid dimensions 909, branching to the subroutine for selecting values for selecting values for analysis of first and second inventive concepts at step 1007 if “Yes”, continuing if “No”; deciding whether to add the grid dimension to the grid record 910, branching to the subroutine for initializing an awareness grid at step 205 if “Yes”, continuing if “No”; and deciding whether a single grid record describing a second inventive concept has already been selected 911, branching to the subroutine for selecting values for analysis of a first inventive concept 1001 at step 1001 if “Yes”, branching to the subroutine for selecting values for analysis of a first inventive concept 1001 at step 1005 if “No”.

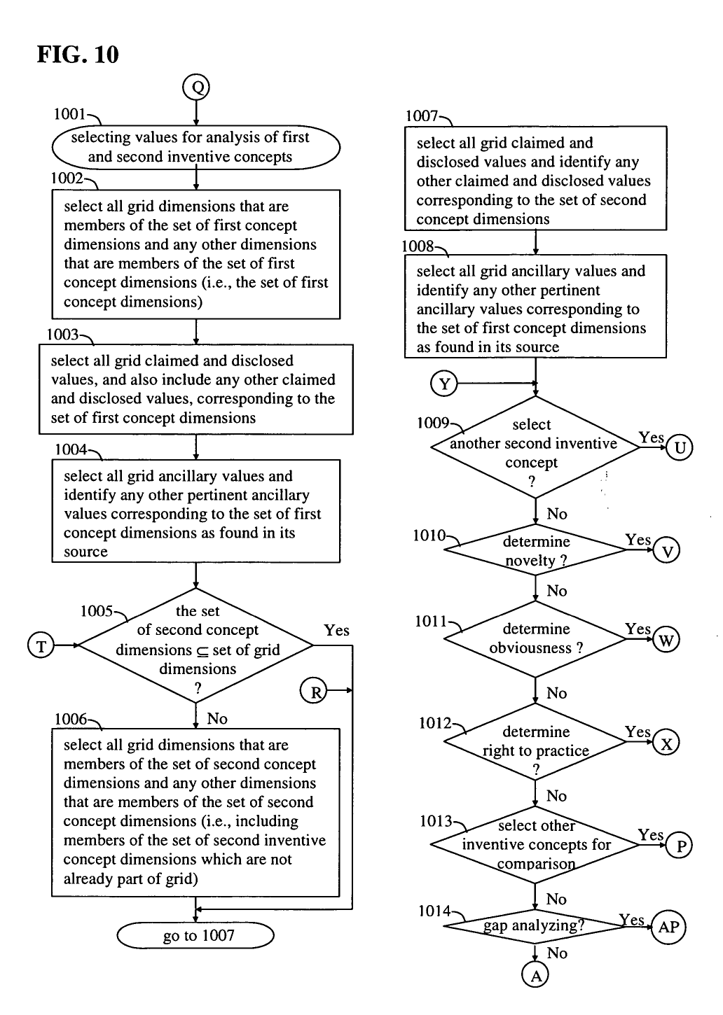

FIG. 10 shows a flowchart for a subroutine for a process of selecting values for analysis of first and second inventive concepts 1001 by: selecting all grid dimensions that are members of the set of first concept dimensions and any other dimensions that are members of the set of first concept dimensions, but not already included as grid dimensions 1002; selecting all grid claimed values and grid disclosed values corresponding to the set of first concept dimensions, and also including claimed and disclosed values for dimension that are not already included as grid dimensions 1003; selecting all grid ancillary values and including any other pertinent ancillary values corresponding to the set of first concept dimensions as found in the source of the first inventive concept 1004; deciding whether the set of second concept dimensions ⊂ the set of grid dimensions 1005, branching to step 1007 if “Yes”, continuing if “No”; selecting all grid dimensions that are members of the set of second concept dimensions and any other dimensions that are members of the set of second concept dimensions (i.e., the set of second concept dimensions) 1006; selecting all grid claimed and disclosed values and identifying any other claimed and disclosed values corresponding to the set of second concept dimensions 1007; selecting all grid ancillary values and identifying any other pertinent ancillary values corresponding to the set of first concept dimensions as found in the source of the first inventive concept 1008; deciding whether to select another second inventive concept 1009, branching to the subroutine for selecting inventive concepts for comparison 901 at step 907 if “Yes”, continuing if “No”; deciding whether to determine novelty 1010, branching to the subroutine for determining novelty 1101 if “Yes”, continuing if “No”; deciding whether to determine obviousness 1011, branching to the subroutine for determining obviousness 1201 if “Yes”, continuing if “No”; deciding whether to determine right to practice 1012, branching to the subroutine for determining right to practice 1301 if “Yes”, continuing if “No”; deciding whether to select other inventive concepts for comparison 1013, branching to the subroutine for selecting inventive concepts for comparison 901 if “Yes”, continuing if “No”; and deciding whether the process for selecting inventive concepts for comparison 901 was entered from the subroutine for gap analyzing 2001, branching to the subroutine for gap analyzing at step 2006 if “Yes”, returning to the master routine 101 if “No”.

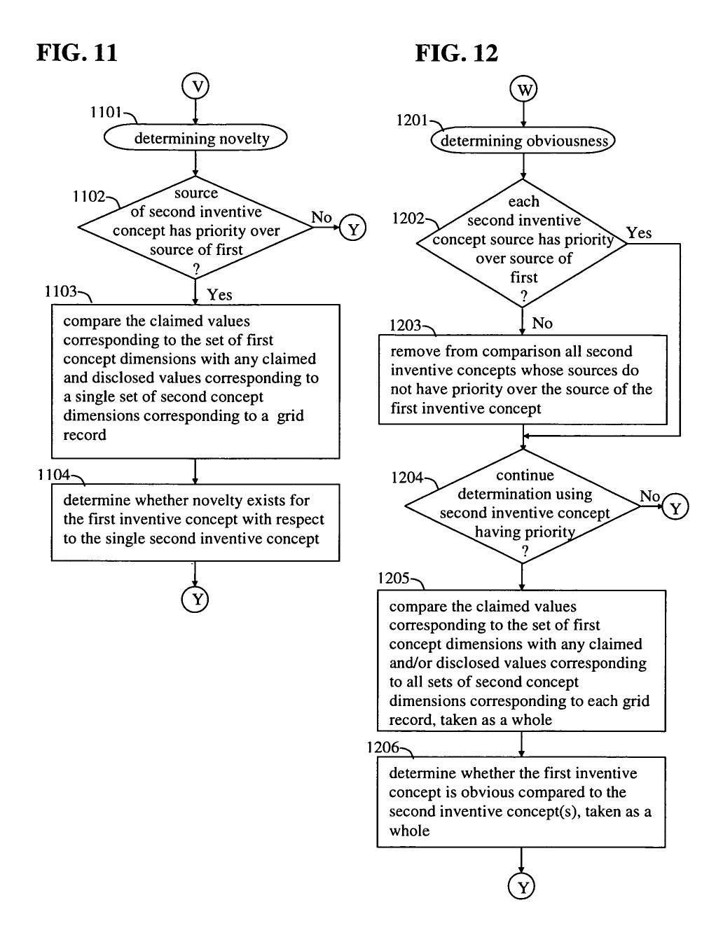

FIG. 11 shows a flowchart for a subroutine for a process of determining novelty 1101 by: deciding whether the source of the a second inventive concept has priority over the source of the first inventive concept 1102, branching to the subroutine for selecting values for analysis of a first inventive concept at step 1009 if “No”, continuing if “Yes”; comparing the claimed values corresponding to the set of first concept dimensions with any claimed and disclosed values corresponding to a single set of second concept dimensions corresponding to a single source 1103; and determining whether novelty exists for the first inventive concept with respect to the single second inventive concept 1104; and branching to the subroutine for selecting values for analysis of first and second inventive concepts 1001 at step 1009.

FIG. 12 shows a flowchart for a subroutine for a process for determining obviousness 1201 by: deciding whether each second inventive concept source has priority over the source of the first inventive concept 1202, branching to step 1204 if “Yes”, continuing if “No”; removing from comparison all second inventive concepts whose sources do not have priority over the source of the first inventive concept 1203; deciding whether to continue determination of obviousness using the second inventive concepts described in sources that do have priority of the source of the first inventive concept 1204, branching to the subroutine for selecting values for analysis of first and second inventive concepts 1001 at step 1009 if “Yes”, continuing if “No”; comparing the claimed values corresponding to the set of first concept dimensions with any claimed and/or disclosed values corresponding to all sets of second concept dimensions corresponding to each source, taken as a whole 1205; determining whether the first inventive concept is obvious compared to the second inventive concept(s), taken as a whole 1206; and branching to the subroutine for selecting values for analysis of first and second inventive concepts 1001 at step 1009.

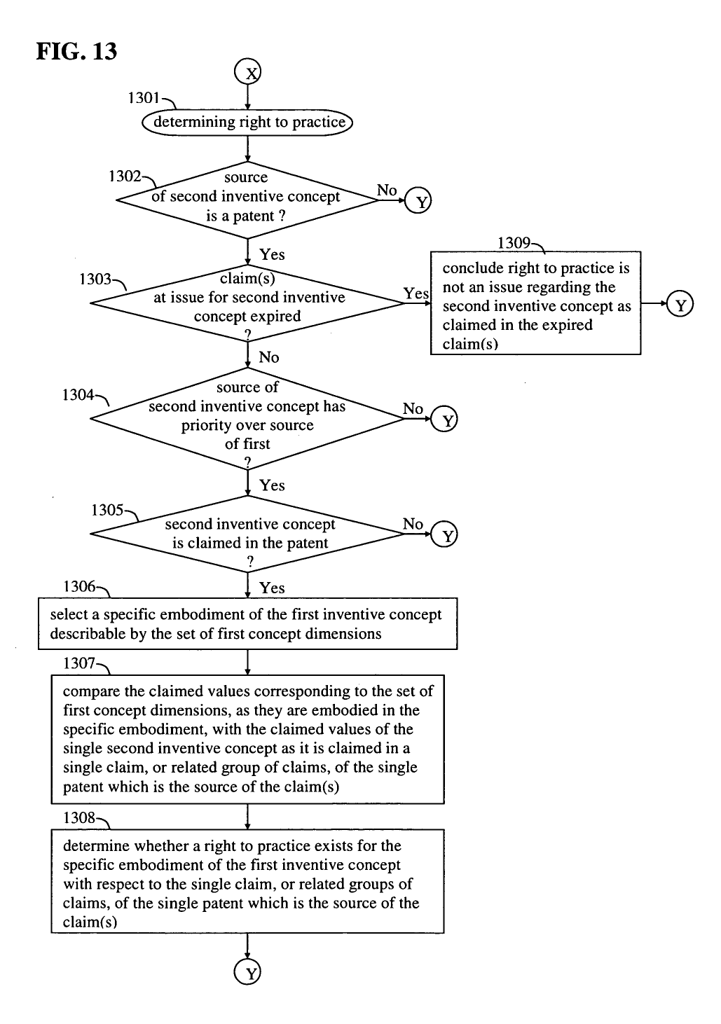

FIG. 13 shows a flowchart for a subroutine for a process for determining right to practice 1301 by: deciding whether the source of a second inventive concept is a patent 1302, branching to the subroutine for selecting values for analysis of a first inventive concept at step 1010 at step 1009 if “No”, continuing if “Yes”; deciding whether a source patent for the claim or claims at issue for the second inventive concept has expired 1303, branching to step 1309 if “Yes”, wherein step 1309 is the step of concluding that right to practice is not an issue regarding the second inventive concept as claimed in the expired claim or claims, and wherein step 1309 is followed by branching to the subroutine for selecting values for analysis of first and second inventive concepts 1001 at step 1009, continuing if “No”; deciding whether a source of the second inventive concept has priority over the source of the first inventive concept 1304, branching to the subroutine for selecting values for analysis of a first inventive concept 1001 at step 1009 if “No”, continuing if “Yes”; deciding whether the second inventive concept is claimed in the patent 1305, branching to the subroutine for selecting values for analysis of a first inventive concept 1001 at step 1009 if “No”, continuing if “Yes”; selecting a specific embodiment of the first inventive concept describable by the set of first concept dimensions 1306; comparing the claimed values corresponding to the set of first concept dimensions, as they are embodied in the specific embodiment, with the claimed values of the single second inventive concept as it is claimed in a single claim, or related group of claims, of the single patent which is the source of the claim(s) 1307; determining whether a right to practice exists for the specific embodiment of the first inventive concept with respect to the single claim, or related groups of claims, of the single patent which is the source of the claim(s) 1308; and branching to the subroutine for selecting values for analysis of first and second inventive concepts 1001 at step 1009.

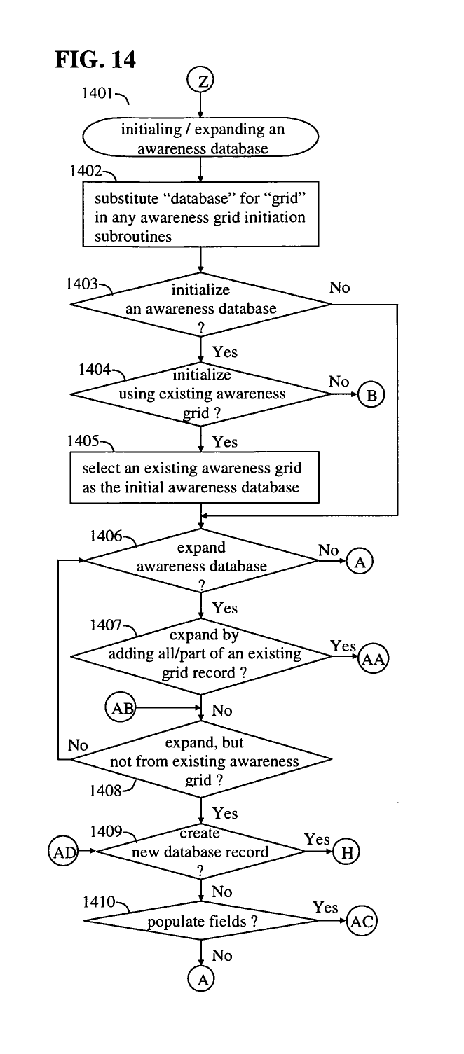

FIG. 14 shows a flowchart for a subroutine for a process of forming and expanding an awareness database 1401 by: substituting “database” for “grid” in any awareness grid initiation subroutines 1402; deciding whether to initialize an awareness database 1403, branching to step 1406 if “No”, continuing if “Yes”; deciding whether to initialize using an existing awareness grid 1404, branching to the subroutine for initializing an awareness grid 201 if “No”, continuing if “Yes”; selecting an existing awareness grid as the initial awareness database 1405; deciding whether to expand an awareness database 1406, branching to the master routine 101 if “No”, continuing if “Yes”; deciding whether to expand the awareness grid by adding all or part of an existing grid record 1407, branching to the subroutine for adding all or part of a grid record to a database 1501 if “Yes”, continuing if “No” deciding whether to expand the awareness database, but not using an existing grid record to do it 1408, branching to step 1406 if “No”, continuing if “Yes”; deciding whether to create a new database record 1409, branching to the subroutine for initializing a grid record (“database record”) 401, if “Yes”, continuing if “No”; and deciding whether to populate fields of the awareness database 1410, branching to the subroutine for populating grid records at step 505 if “Yes”, returning to the master routine 101 if “No”.

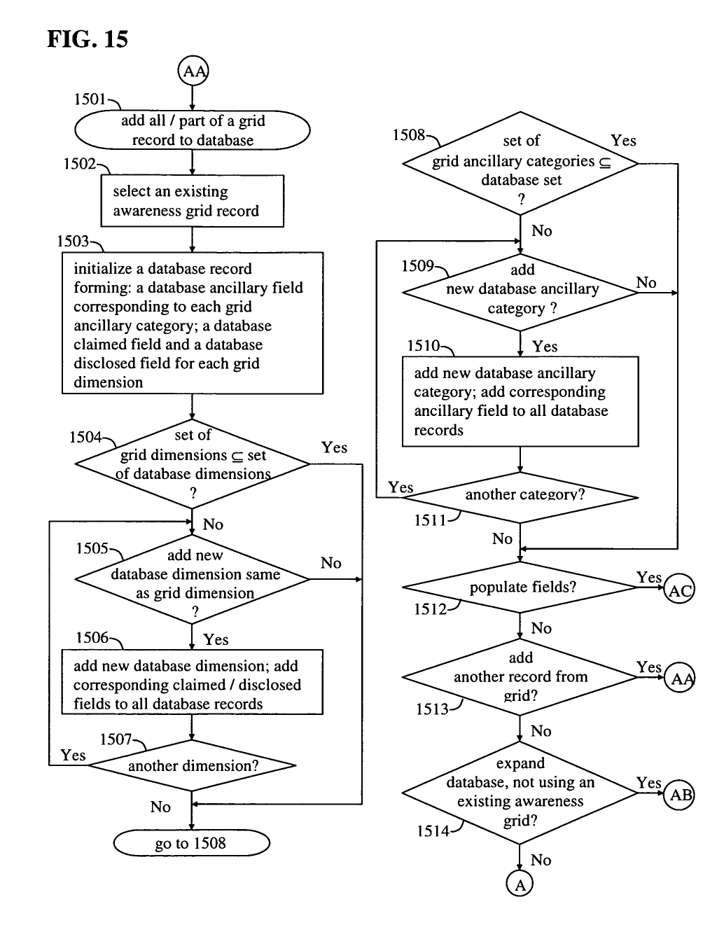

FIG. 15 shows a flowchart for a subroutine for a process of adding all or part of a grid record to an awareness database 1501, by: selecting an existing awareness grid record 1502; initializing a database record, forming a database ancillary field corresponding to each grid ancillary category of the database, and a database claimed field and a database disclosed field for each grid dimension of the database 1503; deciding whether the set of grid dimensions ⊂ the set of database dimensions, branching to step 1508 if “Yes”, continuing if “No”; deciding whether to add a new database dimension which is the same as a grid dimension 1505, branching to step 1508 if “No”, continuing if “Yes”; adding a new database dimension, and adding corresponding claimed fields and disclosed fields to all database records 1506; deciding whether to add another database dimension to the database 1507, branching to step 1505 if “Yes”, continuing if “No”; deciding whether the set of grid ancillary categories ⊂ the database set of ancillary categories 1508, branching to step 1512 if “Yes”, continuing if “No”; deciding whether to add a new database ancillary category to the database 1509, branching to step 1512 if “No”, continuing if “Yes”; adding a new database ancillary category, and adding the corresponding ancillary field to all database records 1510; deciding whether to add another ancillary database category to the database 1511, branching to step 1509 if “Yes”, continuing if “No’; and deciding whether to populate fields 1512, branching to the subroutine for populating grid (database) records at step 505 if “Yes”, continuing if “No”; deciding whether to add another record from the awareness grid to the database 1513, branching to the start of the subroutine for adding all or part of a grid record to a database 1501 if “Yes”, continuing if “No”; and deciding whether to expand the database, but not using an existing awareness grid 1514, branching to the subroutine for initializing an awareness grid at step 203 if “Yes”, returning to the master routine 101 if “No”.

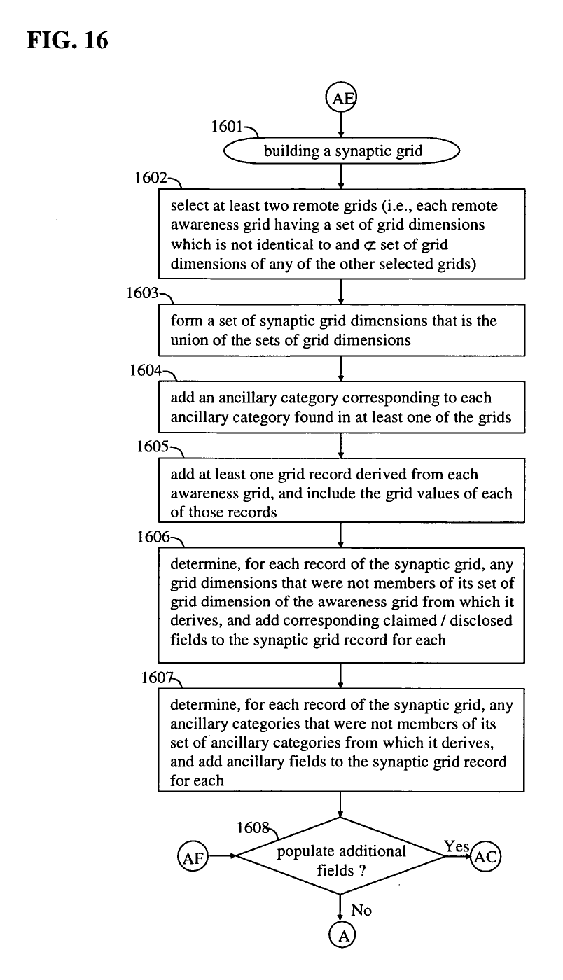

FIG. 16 shows a flowchart for a subroutine for a process of building a synaptic grid 1601 by: selecting at least two remote grids (i.e., each remote grid having a set of grid dimensions which is not identical to and a set of grid dimensions of any of the other selected remote grids 1602; forming a set of synaptic grid dimensions that is the union of the sets of remote grid dimensions 1603; adding an ancillary category corresponding to each ancillary category found in at least one of the remote grids 1604; adding at least one grid record derived from each remote grid, and including the grid values of each of those records in the synaptic grid 1605; determining, for each record of the synaptic grid, any grid dimensions that were not members of its set of grid dimensions of the remote grid from which it derives, and adding corresponding claimed/disclosed fields to the synaptic grid record for each 1606; determining, for each record of the synaptic grid, any ancillary categories that were not members of its set of ancillary categories from which it derived, and adding ancillary fields to the synaptic grid record for each 1607; and deciding whether to populate additional fields of the synaptic grid 1608, branching to the subroutine for populating grid records at step 505 if “Yes”, branching to the master routine 101 if “No”.

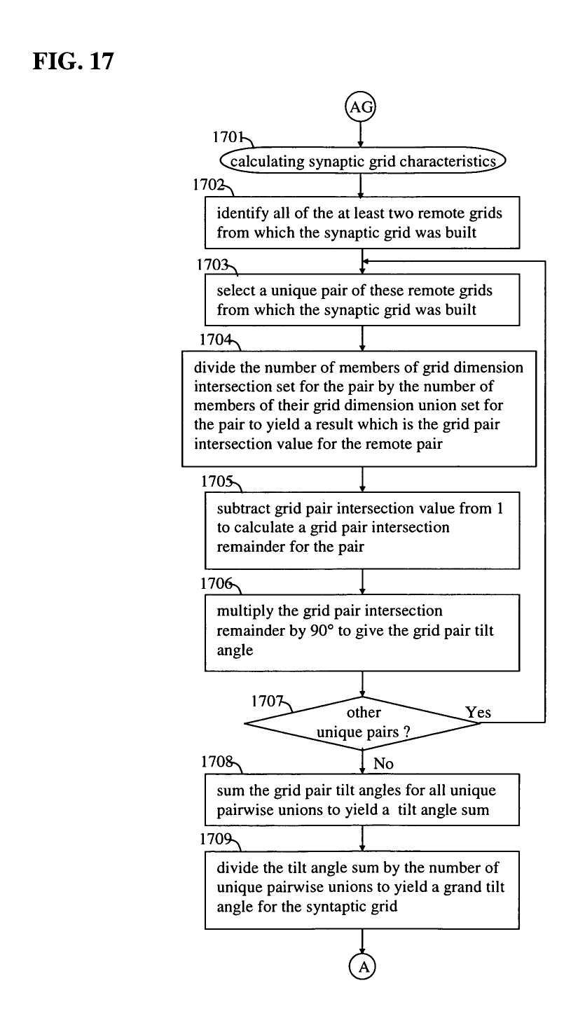

FIG. 17 shows a flowchart for a subroutine for a process of calculating synaptic grid characteristics 1701 by: identifying all of the at least two remote grids from which the synaptic grid was built 1702; selecting a unique pair of these remote grids from which the synaptic grid was built 1703; dividing the number of members of the intersection set of dimensions for the pair of remote grids by the number of members of union set of dimensions for the pair to form a dividend which is the grid pair intersection value for the remote pair 1704; subtracting the grid pair intersection value from the number “1” to give a grid pair intersection remainder for the pair of remote grids 1705; multiplying the grid pair intersection remainder by 90° to give the grid pair tilt angle 1706; deciding whether other unique pairs of remote grid exist 1707, branching to step 1703 if “Yes”, continuing if “No”; summing the grid pair tilt angles for all unique pairwise unions to produce a tilt angle sum 1708; dividing the tilt angle sum by the number of unique pairwise unions to produce a grand tilt angle for the synaptic grid 1709; and returning to the master routine 101.

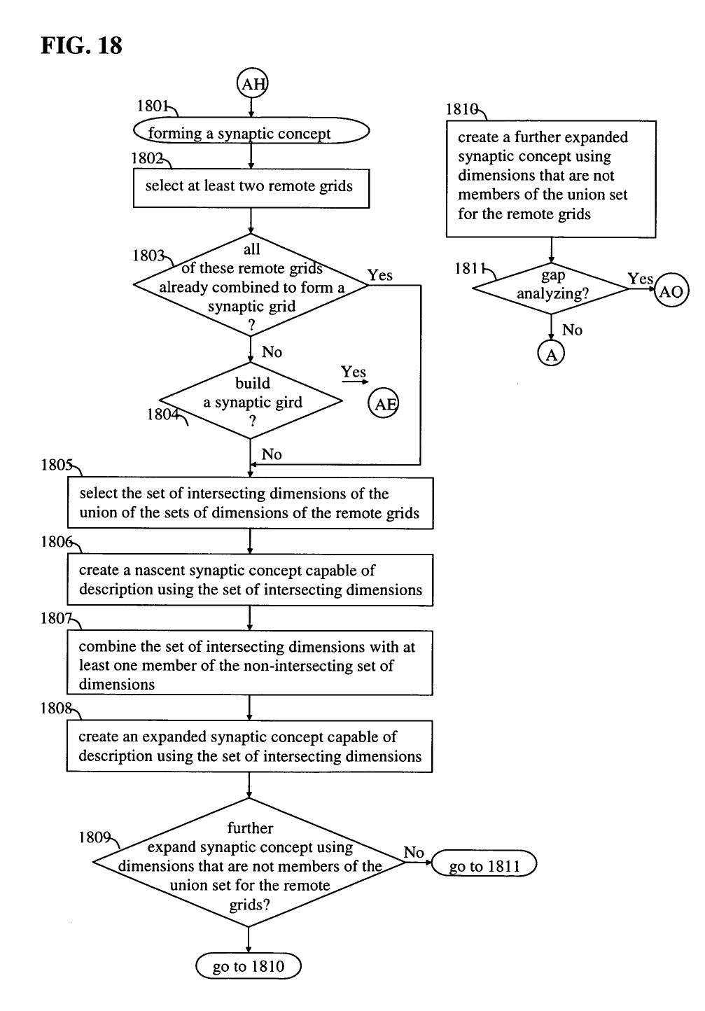

FIG. 18 shows a flowchart for a subroutine for a process of forming a synaptic concept 1801 by: selecting at least two remote grids 1802; deciding whether all of these remote grids have already been combined to form a synaptic grid 1803, branching to step 1805 if “Yes”, continuing if “No”; deciding whether to build a synaptic grid 1804, branching to the subroutine for building a synaptic grid 1601 if “Yes”, continuing if “No”; selecting the set of intersecting dimensions of the union of the sets of dimensions of the remote grids 1805; creating a nascent synaptic concept capable of description using the set of intersecting dimensions 1806; combining the set of intersecting dimensions with at least one member of the non-intersecting set of dimensions of the synaptic grid 1807; creating an expanded synaptic concept capable of description using the set of dimensions which includes the intersecting dimensions and at least one of the non-intersecting dimensions of the synaptic grid 1808; deciding whether to further expand the synaptic concept using dimensions that are not members of the union set for the remote grids 1809, returning to the master routine if “No”, continuing if “Yes”; creating a further expanded synaptic concept using dimensions that are not members of the union set for the remote grids as well as members of the union set 1810; and deciding whether the process for selecting inventive concepts for comparison 901 was entered during the process of gap analyzing 2001, branching to the subroutine for gap analyzing at step 2005 if “Yes”, returning to the master routine 101 if “No”.

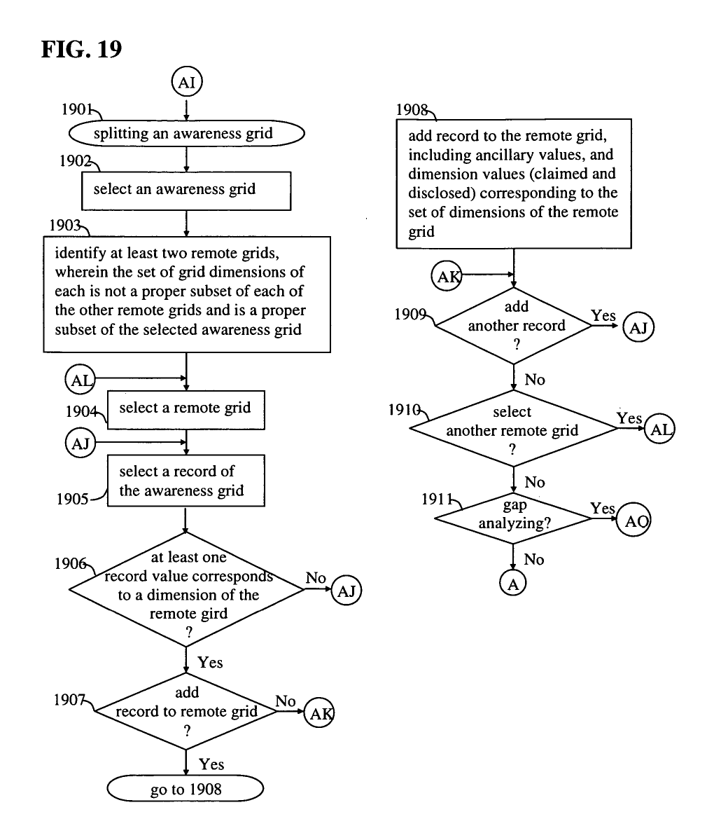

FIG. 19 shows a flowchart for a subroutine for a process of splitting an awareness grid 1901 by: selecting an awareness grid 1902; identifying at least two remote grids, wherein the set of grid dimensions of each is not a proper subset of any of the other remote grids identified, but is a proper subset of the selected awareness grid 1903; selecting a remote grid 1904; selecting a record of the awareness grid being split 1905; deciding whether at least one record value of the awareness grid being split corresponds to a dimension of the remote grid 1906, branching to step 1905 if “No”, continuing if “Yes”; deciding whether to add a record to the remote grid 1907, branching to step 1909 if “No”, continuing if “Yes”; adding a record to the remote grid, including ancillary values, and dimension values (claimed and disclosed) corresponding to the set of dimensions of the remote grid 1908; deciding whether to add another record 1909, branching to step 1905 if “Yes”, continuing if “No”; deciding whether to select another remote grid 1910, branching to step 1904 if “Yes”, continuing if “No”; and deciding whether the subroutine for splitting an awareness grid 1901 was entered during the process of gap analyzing 2001, branching to the subroutine for gap analyzing at step 2005 if “Yes”, returning to the master routine 101 if “No”.

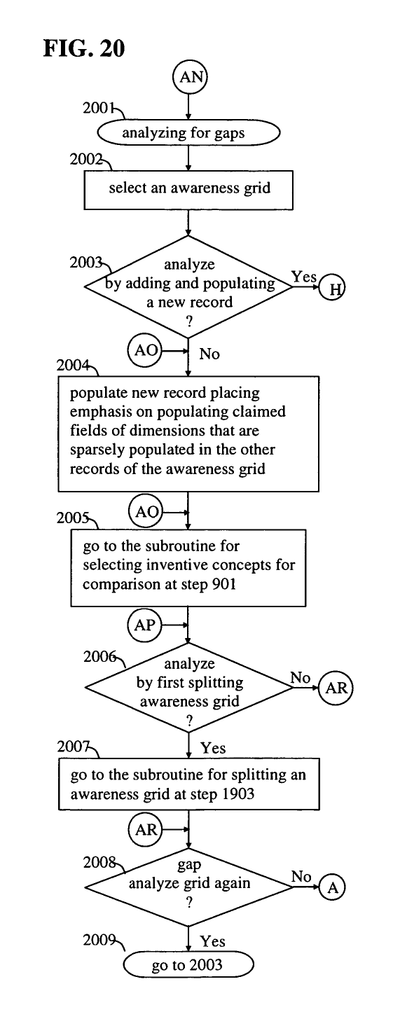

FIG. 20 shows a flowchart for a subroutine for a process of analyzing for gaps 2001 by: selecting an awareness grid to be gap analyzed 2002; deciding whether to gap analyze by adding and populating a new record of the awareness grid 2003, branching to the subroutine for initializing a grid record 401 if “Yes”, continuing if “No”; populating the new record placing emphasis on populating claimed fields of dimensions that are sparsely populated in the other records of the awareness grid 2004; going 2005 to the subroutine for selecting inventive concepts for comparison at step 901; deciding whether to gap analyze by first splitting the awareness grid 2006, branching to step 2008 if “No”, continuing if “Yes”; going 2007 to the subroutine for splitting an awareness grid at step 1903; deciding whether to gap analyze again using the awareness grid 2008, branching to step 2003 if “Yes”, returning to the master routine if “No”.

The examples which follow illustrate various embodiments of the present invention.

### GENERAL PROCEDURES AND DESCRIPTIONS USED FOR THE EXAMPLES

The examples which follow demonstrate various embodiments of the present invention as disclosed in the flowchart of FIGS. 1-20. Those embodiments include: awareness grids A, B, and C corresponding to three technology areas, along with their preparation; synaptic grids formed from various combinations of three remote grids, wherein the remote grids are awareness grids A, B, and C; calculation of characteristics of those synaptic grids to give numerical approximations of the degree of overlap of the technology areas which are the subject of the remote grids which were combined in forming the synaptic grid.

Awareness grids A, B, and C contain information on inventive concepts disclosed in four, three, and three sources, respectively. It should be understood that awareness grids designed to capture the closely related art for a particular technology area may contain many records, depending upon the breadth of the technology chosen for analysis, upon the amount of work that has already been done in that technology area, and upon the questions to be answered. In practice, awareness grids containing a few, tens, or hundreds of records have been prepared, and there is no limit to the number of records that can be included, if appropriate. In addition, some sources may contain more than one inventive concept. In such case, it is common to include more than one record for the same source, each pertaining to a different inventive concept, provided, of course, that each inventive concept is related to the subject of the awareness grid. It should be further understood that reasonable people skilled in the art may differ on the specifics of selection of dimensions for inclusion in a given awareness grid. Typically, those selecting and naming dimensions, will select aspects of preparation of compositions, of the compositions themselves, uses of the compositions, and/or of characteristics of these compositions and processes. The guiding principle for selection of dimensions is that the dimensions selected provide a representation of the actual inventive concepts of the technology area of interest. In practice, once the dimensions have been selected, records are created for the inventive concepts contained in selected sources. During this process of creating and populating records, it is common to add new dimensions and to delete, or modify, existing dimensions. It may, further, become apparent that new ancillary fields should be added, such as fields containing additional metadata regarding sources, or fields containing additional links to related information.

There may, further, be an inventive concept from an area of technology that overlaps, but does not fall within the technology area described by a given awareness grid, yet it is considered that a record should be created in the awareness grid to describe that inventive concept. In such case, claimed and disclosed values should be entered for dimensions of that awareness grid which are included in the awareness grid, while additional aspects of that inventive concept should be described in, for example, a field reserved for comments on what is claimed or disclosed. Such inclusion of inventive concepts describable by a set of dimensions that intersects with, but is not a subset of, the set of grid dimensions of the awareness grid flexibly expands the utility of the given awareness grid.

Awareness Grids A, B, and C of Tables 2, 3, and 4 respectively have the following designations for ancillary categories, dimensions, and records. Records are labeled by indicating the awareness grid and a record number within that grid. For example, “A-R2” in the first column of Table 2 indicates that the record found in the corresponding row is record number 2 of Awareness Grid A. Similarly, “A-A5” in the first row of Table 2 indicates the column for the fifth ancillary category of Awareness Grid A. Further, “A-D4-c” indicates the column containing fields designated to contain claimed values for dimension 4 of Awareness Grid A, and “A-D4-d” indicates the column containing fields designated to contain disclosed values for dimension 4 of Awareness Grid A. Because what is claimed regarding an inventive concept is, by definition, part of the disclosure of a patent or a patent application, it is not necessary to restate in a “disclosed field” what has already been included in the “claimed field” for the same dimension. It is sufficient to simply include in the “disclosed field” disclosed dimension values that are beyond what is claimed. As such, repetition of claimed values in corresponding disclosed fields is optional.

### Example 1

### Awareness Grid a Directed to Dispersions of Active Ingredients

Table 2 is Awareness Grid A directed to the technology area of dispersions that contain an active ingredient. Awareness Grid A includes ancillary data (columns A-A1 through A-A6), and dimensions both claimed (A-D1-c through A-D7-c) and disclosed (A-D1-d through A-D7-d). Awareness Grid A further includes records (A-R1 through A-R4) for inventive concepts contained in each of four sources, each of which is a patent. The fields of each of the four records of Awareness Grid A were populated with claimed dimension values, and disclosed dimension values found in the source for which the record was created. The ancillary data values were also found within each source, although such ancillary values may often be found in secondary sources such as commercial databases. Although not included in this awareness grid, ancillary fields such as those directed to, for example, legal status would be populated from external sources. In addition, one or more ancillary fields may be populated with links to computer-based sites which contain relevant information such as, for example: full text of the source; claims, if the source is a patent or patent application; file wrapper information on the database of a patent office.

The values placed in a each claimed dimension field of Awareness Grid A represent what is claimed about that dimension of the inventive concept described in that record. The values placed in a each disclosed dimension field of Awareness Grid A represent what is disclosed about that dimension of the inventive concept described in that record. Awareness Grid A was initialized, and its grid dimensions and ancillary categories were identified and created according to the subroutine of FIG. 2. Its grid records were initialized according to the FIG. 4 subroutine. Assessment of the need to add a proposed concept dimension or ancillary category to Awareness Grid A were made according to the FIG. 3 subroutine. Population of the grid records of Awareness Grid A was accomplished according to the subroutines of FIGS. 5-8.

### Example 2

### Awareness Grid B Directed to Aqueous Emulsion and Microemulsion Polymerization

Table 3 is Awareness Grid B directed to the technology area of aqueous emulsion and microemulsion polymerization. Awareness Grid B was prepared according to the method described in Example 1. Awareness Grid B includes ancillary data (columns B-A1 through B-A6), and dimensions both claimed (B-D1-c through B-D12-c) and disclosed (B-D1-d through B-D12-d). Awareness Grid B further includes records (B-R1 through B-R3) for inventive concepts contained in each of three sources, two of which are journal articles, and one of which is a patent.

### Example 3

### Awareness Grid C Directed to Condensation Polymerization

Table 4 is Awareness Grid C directed to the technology area of condensation polymerization. Awareness Grid C was prepared according to the method described in Example 1. Awareness Grid C includes ancillary data (columns C-A1 through C-A6), and dimensions both claimed (C-D1-c through C-D8-c) and disclosed (C-D1-d through C-D8-d). Awareness Grid C further includes records (C-R1 through C-R3) for inventive concepts contained in each of three sources, one of which is a journal article, and two of which are patents.

### Example 4

### Synaptic Grid AB: Building Synaptic Grid AB by Merging Awareness Grids A and B, Forming the Union of their Grid Dimension Sets

Table 5 represents Synaptic Grid AB which was built by merging Awareness Grid A with Awareness Grid B, forming the union of their grid dimension sets, according to the subroutine of FIG. 16. For the sake of brevity, the ancillary values, claimed dimension values, and disclosed dimension values are not repeated in Synaptic Grid AB, but can be found in the ancillary, claimed dimension, and disclosed dimension fields, respectively, of Awareness Grids A and B. Awareness Grids A and B are remote grids with respect to each other because their grid dimensions sets are not identical and neither of those grid dimension sets is a proper subset of the other. That is, each of grids A and B has at least one dimension not found in the other. Characteristics of Synaptic Grid AB are calculated according to the FIG. 17 subroutine (see also Table 1). The union set of dimensions contains 15 dimensions, while the intersection set (i.e., the set containing those dimensions common to both Awareness Grid A and B) contains 4 members. The grid pair intersection value for the union of remote grids A and B is then 4/15=0.27, and the grid pair tilt angle is (1−0.27)*90°=66°. A grid pair tilt angle of 0° would have indicated that the technology area described by Grid A was identical to that described by Grid B. A grid pair tilt angle of 90° would have indicated that the two technology areas do not overlap, based on the absence of common dimensions. Grid pair tilt angles near 0° are often associated with incremental changes, while grid pair tilt angles approaching 90° are often associated either with no useful invention, or with breakthrough invention. Therefore, a grid pair tilt angle of 66° provides an estimation that the two technology areas have limited overlap and that Synaptic Grid AB may provide a fertile basis for creation of new inventive concepts.

### Example 5

### Synaptic Grid AC: Building Synaptic Grid AC by Merging Awareness Grids A and C, Forming the Union of their Grid Dimension Sets

Table 6 represents Synaptic Grid AC which was built by merging Awareness Grid A; with Awareness Grid C, forming the union of their grid dimension sets, according to the subroutine of FIG. 16. Table 6 is structured in the same way as was Table 5, and characteristics were calculated as in Example 4. Awareness Grids A and C are remote grids with respect to each other. The union set of dimensions contains 16 dimensions, while the intersection set contains no members (i.e., the intersection set of concept dimensions is a null set). The grid pair intersection value for the union of remote grids A and C is then 0/16=0.00, and the grid pair tilt angle is (1−0.00)*90°=90°. Synaptic Grid AC provides great potential for further creation of inventive concepts. Although the likelihood that a truly useful invention will be created may be decreased at high tilt angles, the likelihood increases greatly that, if a useful inventive concept is created, it will be a breakthrough inventive concept.

### Example 6

### Synaptic Grid BC: Building Synaptic Grid BC by Merging Awareness Grids B and C, Forming the Union of their Grid Dimension Sets

Table 7 represents Synaptic Grid BC which was built by merging Awareness Grid B with Awareness Grid C, forming the union of their grid dimension sets, according to the subroutine of FIG. 16. Table 7 is structured in the same way as was Table 5, and characteristic are calculated as in Example 4. Awareness Grids B and C are remote grids with respect to each other. The union set of grid dimensions contains 18 dimensions, while the intersection set contains 3 members (i.e., 3 common dimensions). The grid pair intersection value for the union of remote grids B and C is then 3/18=0.17, and the grid pair tilt angle is (1−0.17)*90°=75°. Synaptic Grid BC again provides excellent potential for further creation of inventive concepts.

### Example 7

### Synaptic Grid ABC: Building Synaptic Grid ABC by Merging Awareness Grids A, B, and C, Forming the Union of their Grid Dimension Sets

Table 8 represents Synaptic Grid ABC which was built by merging Awareness Grids A, B, and C, forming the union of their grid dimension sets, according to the subroutine of FIG. 16. Table 8 is structured in the same way as was Table 5, and characteristic were calculated according to the FIG. 17 subroutine (see also Table 1). Awareness Grids A, B, and C are remote grids with respect to each other. Unlike the synaptic grids AB, AC, and BC, respectively, of Examples 4, 5, and 6, all of which are formed from two remote grids by a single pairwise pathway, Synaptic Grid ABC can be formed by three unique pairwise pathways, involving a total of six merging possibilities. That is, starting with remote grids A, B, and C, Synaptic Grid ABC can be formed by: merging Grid A with Grid B to give Synaptic Grid AB (grid pair intersection value=0.27, grid pair tilt angle=66°), and then merging Grid AB with Grid C (grid pair intersection value=0.14, grid pair tilt angle=77°); merging Grid A with Grid C to give Synaptic Grid AC (grid pair intersection value=0.00, grid pair tilt angle=90°), and then merging Grid AC with Grid B (grid pair intersection value=0.33, grid pair tilt angle=60°); or merging Grid B with Grid C to give Synaptic Grid BC (grid pair intersection value=0.17, grid pair tilt angle=75°), and then merging Grid BC with Grid A (grid pair intersection value=0.19, grid pair tilt angle=73°). The average grid pair intersection value for the six merging possibilities is 0.18, which corresponds to a tilt angle of 74°. Given that the grid pair tilt angles range from 60° to 90° for the six pairwise combinations, it is anticipated that Synaptic Grid ABC again provides excellent potential for further creation of inventive concepts beyond what is found in, or suggested by, the constituent remote awareness grids.

### Example 8

### Awareness Database A: Entire Database is Awareness Grid A

Awareness Grid A can also be considered to be an entire awareness database, Awareness Database A, built according to the subroutines of FIGS. 14 and 15. Awareness Grid A has the same structure as an awareness database (see Table 2).

### Example 9

### Awareness Database AB: Entire Database is Synaptic Grid AB

An awareness database can be built one dimension, one ancillary category, and one record at a time, or even on field at a time. Alternatively, an awareness database can be built by merging existing awareness grids. Of course, combinations of both techniques are also within the scope of the present invention (see FIGS. 14 and 15). Synaptic Grid AB (see Table 5) can, therefore, be considered to be an entire awareness database, Awareness Database AB, built by merging two awareness grids, according to the subroutines of FIGS. 14 and 15.

### Example 10

### Awareness Database ABC: Entire Database is Synaptic Grid ABC

Synaptic Grid ABC can also be considered to be an awareness data formed from multiple existing awareness grids A, B, and C. Database ABC is then representative of much larger awareness databases that can be built and expanded using the subroutines of FIGS. 14 and 15, and, when appropriate, other related subroutines governed by the FIG. 1 master routine. Large commercial, or in-house, awareness databases can be built encompassing hundreds of awareness grids. In fact, there is no particular limit on the number of concept dimensions, ancillary categories, records, or awareness grids that can be encompassed by an awareness database. Custom awareness databases can be built In-house, or by outside contract firms, to support the invention/innovation goals of a research team, of an entire research organization, or of research consortia, both industrial and commercial. In another example, art units at the United States Patent and Trademark Office, or other patent office, could benefit greatly from the existence of an awareness database containing the art most closely related to the technology areas for which the patent examiners of that art unit have responsibility.

### Example 11

### Forming a Synaptic Concept Based on the Set of Intersecting Dimensions of Synaptic Grid AB

First a nascent concept was formed based upon Synaptic Grid AB (see Table 5 which represents that synaptic grid, and Tables 2 and 3 which, respectively, contain the actual values of awareness grids A and B which, upon merging, became values in Synaptic Grid AB). The nascent concept was formed according to the FIG. 18 subroutine and other related subroutines governed by the FIG. 1 master routine, based on the members of the set of intersecting dimensions for the union of the set of concept dimensions of Awareness Grid A (directed to dispersions of active ingredients) and the set of concept dimensions of Awareness Grid B (directed to aqueous emulsion and microemulsion polymerization). The four members of the intersection set of concept dimensions for Synaptic Grid AB are: carrier medium; dispersed phase medium; dispersant; and dispersant amount. The nascent inventive concept formed using those four dimensions was: “an aqueous dispersion of a hydrophobic phase including a hydrophobic substance, wherein the hydrophobic phase is rendered stable by a dispersant which is an anionic surfactant present in the aqueous dispersion at 0.1 to 5.0 weight percent, based on the total weight of the hydrophobic phase”. This is an example of the nascent concept of the present invention. Such nascent concepts may be quite broad, or quite narrow in focus, or somewhere in between. A given synaptic grid will, typically, yield multiple nascent concepts. Further, the nascent concept may itself be patentable in some cases. In other cases, the nascent concept will serve as a framework upon which synaptic concepts may be formed by the creative mind.

Again in accord with the FIG. 18 subroutine and other related subroutines governed by the FIG. 1 master routine, the set of concept dimensions, to be used for expanding the nascent concept to form a synaptic concept, was expanded by including a dimension from Awareness Grid A (delivered ingredient) and a dimension from Awareness Grid B (polymer), each of which was not a member of the set of concept dimensions for the other awareness grid, i.e., not a member of the intersection set of dimensions. The “delivered ingredient” was selected to be a “hydrophobic bioactive ingredient”, while the “polymer” was selected to be “a (meth)acrylic polymer”. The synaptic concept then became: “an aqueous dispersion including a hydrophobic phase dispersed in an aqueous medium, wherein the hydrophobic phase includes a hydrophobic bioactive ingredient dissolved in polymer particles: wherein the polymer particles are rendered stable by a dispersant which is an anionic surfactant present in the aqueous dispersion at 0.1 to 5.0 weight percent, based on the total weight of the hydrophobic phase; wherein the hydrophobic bioactive ingredient is selected from pharmaceuticals or pesticides; and wherein the polymer is a (meth)acrylic polymer”. This synaptic concept is an example of the many synaptic concepts that exist at the intersection of the dimensions of awareness grids A and B, and for which Synaptic Grid AB provides a fertile informational basis for the creative mind of an inventor. This synaptic concept was further expanded by adding a new dimension to Synaptic Grid AB when it was realized that the attachment of “neutralizable functional groups” to the polymer could render that polymer water soluble or water swellable at a later time, that is during delivery to a target organism. The new dimension then became “neutralizable functional group”, and a further expanded synaptic concept became the above synaptic concept having the further element that “the polymer is a polymer bearing a neutralizable functional group capable of providing triggered release of the hydrophobic bioactive ingredient upon neutralization”. Other of the members of the set of non-intersecting dimensions formed by the union of awareness grids A and B, were further used to in creating another synaptic concept. The concept dimension particle size (Awareness Grid B) was used to define synaptic concepts for emulsions (particle size=0.050 to 1.0 microns), for suspensions (particle size=greater than 1.0 to 500 microns), and microemulsions (particle size=0.005 to less than 0.050 microns). Because the values contained in the claimed and disclosed fields for a particular group of dimensions of a given awareness grid may be limited in what they disclose, it is further possible that even a nascent concept may itself be a synaptic concept which is beyond the scope of the inventive concepts captured in the synaptic grid. This can be done by, for example, imagining new and useful values for existing dimensions, or new and useful combinations of existing values.

### Example 12

### Forming a Synaptic Concept Based on the Set of Intersecting Dimensions of Synaptic Grid ABC Formed by the Intersection of Synaptic Grid AB with Awareness Grid C

First a nascent concept was formed based upon Synaptic Grid ABC (see Table 8 which represents that synaptic grid, and Tables 2, 3, and 4 which, respectively, contain the actual values of awareness grids A, B, and which became values in Synaptic Grid ABC). The nascent concept was formed according to the FIG. 18 subroutine and other related subroutines governed by the FIG. 1 master routine, based on the members of the set of intersecting dimensions for the union of the set of concept dimensions of Synaptic Grid AB (directed to dispersions of active ingredients and to aqueous emulsion and microemulsion polymerization) and the set of concept dimensions of Awareness Grid C (directed to condensation polymerization). The three members of the intersection set of concept dimensions for Synaptic Grid ABC prepared by merging Synaptic Grid AB with Awareness Grid C are: polymer synthesis type; polymer; and polymer molecular weight. The nascent inventive concept formed using those three dimensions was: “a polymer having a number average molecular weight of 50,000 to 1,500,000, wherein the polymer is a polymer made by a polymerization method selected from: condensation polymerization in non-aqueous solvent; aqueous emulsion polymerization; and aqueous microemulsion polymerization”. This is an example of the nascent concept of the present invention.

Again in accord with the FIG. 18 subroutine and other related subroutines governed by the FIG. 1 master routine, the set of concept dimensions, to be used for expanding the nascent concept to form a synaptic concept, was expanded by including dimensions from Synaptic Grid AB and Awareness Grid C which were members of the set of concept dimensions for the other awareness grid. Those non-intersecting dimensions included those utilized to create the synaptic concepts of Synaptic Grid AB, as well as these dimensions of Awareness Grid C: first condensation monomer; and second condensation monomer. The synaptic concept then became: “an aqueous dispersion including a hydrophobic phase dispersed in an aqueous medium, wherein the hydrophobic phase includes a hydrophobic bioactive ingredient dissolved in polymer particles: wherein the polymer particles are rendered stable by a dispersant which is an anionic surfactant present in the aqueous dispersion at 0.1 to 5.0 weight percent, based on the total weight of the hydrophobic phase; wherein the hydrophobic bioactive ingredient is selected from pharmaceuticals or pesticides; and wherein the polymer is a (meth)acrylic polymer, or a condensation polymer, wherein that condensation polymer is a polyurea, a polyurethane, or a polyacrylamide”. This synaptic concept is an example of the many synaptic concepts that exist at the intersection of the dimensions of Synaptic Grid AB and Awareness Grid C providing a fertile informational basis for the creative mind of an inventor.

### Example 13

### Gap Analyzing: Splitting Awareness Grid ABC into Constituent Remote Grids A, B, and C, Followed by Selecting Remote Grid A and Adding Non-Intersecting Dimensions from Awareness Grid ABC

In this example, we consider Synaptic Grid ABC as simply being Awareness Grid ABC. That is, we consider Awareness Grid ABC as if we were given it and have no idea how it was built. The procedure of gap analyzing (see FIGS. 19 and 20, and related subroutines governed by the FIG. 1 master routine) exemplified here is closely related to providing the basis for formation of synaptic concepts, given in Examples 4, 5, 6, and 7, by merging hitherto unmerged remote grids. Here, however, an existing awareness grid (Grid ABC) is first split into remote grids. In this case, those remote grids happen to be awareness grids A, B, and C. That is, the awareness grid of Table 8 is split into remote grids A, B, and C. Once Awareness Grid ABC was split, remote grid B was selected and a nascent concept was formed using the dimensions of remote grid B (Table 3). The nascent concept became: “an aqueous dispersion of polymeric particles wherein the polymeric particles are stabilized by a dispersant present in an amount of 0.1 to 5.0 weight percent, based on the total weight of the polymeric particles, wherein the polymeric particles: include a polymer selected from polyacrylate and polymethacrylate; and have an average particle diameter of 0.050 to 1.0 microns”.

The set of dimensions which served as the basis for creating the nascent concept was then expanded to include dimensions from Awareness Grid ABC, the claimed and disclosed fields of which were sparsely populated. The first two such dimensions selected were: “first condensation monomer” and “second condensation monomer”. Scrutiny of the nascent concept from the perspective of the two added dimensions suggested the possibility that an expanded concept, a “gap concept” could be created in which the polymeric particles could include a “polycondensation polymer” as well as polyacrylate and polymethacrylate polymers. A third sparsely populated dimension, “solvent”, was then added suggesting this gap concept: “an aqueous dispersion of polymeric particles formed by: (a) dispersing droplets of a solution of a first condensation monomer in a hydrophobic solvent into water; (b) forming a stable dispersion of the droplets in the presence a dispersant present in an amount of 0.1 to 5.0 weight percent, based on the weight of the droplets; (c) adding a second condensation monomer to the dispersion; (d) polymerizing the first and second condensation monomers to form a condensation polymer, wherein the condensation polymer is insoluble in the solvent, forming a solid shell around the solvent, and wherein the solvent droplet with its polymeric shell has an average diameter of 0.050 to 5.0 microns”. Adding another dimension, that of “deliverable ingredient” provides informational background for yet another gap concept in which a droplet containing active ingredient, with or without solvent, is formed.

### Example 14

### Selecting Inventive Concepts for Comparison

The subroutines of FIGS. 9 and 10, and related subroutines governed by the FIG. 1 master routine, describe selection of inventive concepts for comparison. FIG. 9 describes selection of a first inventive concept which is to be compared with one or more second inventive concepts, and further describes selection of the second inventive concept(s). The first inventive concept may already be described in an awareness grid or may not be. In fact, the first inventive concept may be newly created by an inventor. In the latter case, the first inventive concept is described in terms of a set of concept dimensions, and, if an awareness grid already exists capable of describing that first inventive concept, it is often desirable to create a new record for the first concept on that awareness grid. The second inventive concept may already be described in a record of the awareness grid. If not, it should be added before making any comparison with the first inventive concept. There may be more than one second inventive concept of interest for comparison with the first inventive concept. Further, in the course of adding any of these inventive concepts to the awareness grid, there may be occasion to expand the awareness grid by adding one or more new dimensions to the set of concept dimensions of that grid. FIG. 10 describes selection of grid ancillary values, grid claimed values, and grid disclosed values to be used in comparisons, and further has branch points for making novelty, obviousness, and right-to-practice decisions, as well as gap analyzing. The subroutine of FIG. 10 further allows for making comparisons using dimensions that are not in the set of grid dimensions of the awareness grid being consulted in the comparison. This takes into account the fact that there will often be grid records for an inventive concept having a set of concept dimensions that intersects with, but is not a subset of, the awareness grid which contains the grid record.

### Example 15

### Novelty Decisions. Using Awareness Grids to Make Decisions Relating to Novelty

While it is understood that final decisions relating to whether a given inventive concept is novel, with respect to a given prior art inventive concept, are best made by intellectual property practitioners (e.g., patent examiners, patent attorneys, and patent agents), it is useful and efficient to consult an awareness grid to make a quick determination of which of the records of the grid are directed to inventive concepts (i.e., the second inventive concepts of FIGS. 9-11) that may pose novelty issues for a particular inventive concept (i.e., the first inventive concept of FIGS. 9-11). In practice, it is usually possible to dismiss most of the records of awareness grids, particularly those grids containing tens, or hundreds of records, almost at a glance, or by means of a quick sort. For example, when an awareness grid is structured as an Excel™ spreadsheet, a glance may literally be all that is required to eliminate many references. Consider Awareness Grid ABC as it is represented by Table 8. Table 8 is a mere representation of the actual Synaptic Grid ABC formed by merging awareness grids A, B, and C. The Table 8 representation has records with collapsed dimension fields (i.e., a single field to represent whether there are, for a given dimension of a given record: claimed values, represented by “c”; disclosed, but not claimed values, represented by “d”; or no values (empty)). The actual values for claimed, disclosed, and ancillary fields are not given. In spite of this lack of actual values, records B-R1 to B-R3 and C-R1 to B-R3 can be dismissed as novelty issues when a first inventive concept capable of description using dimensions *1 through * 7, but not dimensions *8 through *21, is considered. In practice, the entire awareness grid with values in appropriate fields is analyzed. Simple sorting may to utilized to, for example, determine whether a given second inventive concept as disclosed by a specific source is actually prior art. More complex sorting (e.g., the AUTOFILTER™ sorting tool of an EXCEL™ spreadsheet) is particularly useful when ancillary data fields exist containing tags which further augment sorting. Once records containing second inventive concepts which may raise novelty issues have been identified, an in-depth comparison can be made by scrutinizing, for example, the full text of the source through a direct electronic link to a commercial database, wherein that link is contained in an ancillary data field.

As indicated in the FIG. 11 subroutine, a first inventive concept is described by a set of claimed dimensions and compared with what is disclosed in a single record of the awareness grid.

### Example 16

### Obviousness Decisions

While it is understood that final decisions relating to whether a given inventive concept is obvious, with respect to one or more prior art inventive concepts, are best made by intellectual property practitioners (e.g., patent examiners, patent attorneys, and patent agents), it is useful and efficient to consult an awareness grid to make a quick determination of which of the records of the grid are directed to inventive concepts (i.e., the second inventive concepts of FIGS. 9-10 and 12) that may pose obviousness issues for a particular inventive concept (i.e., the first inventive concept of FIGS. 9-10 and 12). As indicated in the FIG. 12 subroutine, a first inventive concept is described by a set of claimed dimensions and compared with what is disclosed in a one or more records of the awareness grid, those records taken as a whole. Because of the complexity of the decisions surrounding obviousness, it may be necessary to consult the full text of source documents more frequently than is necessary when making initial assessment of novelty.

### Example 17

### Right-to-Practice Decisions

The FIG. 13 subroutine (see also FIGS. 9 and 10) is directed to determination of right to practice a specific embodiment of an inventive concept (i.e., practicability). If a specific product concept is contemplated for commercial offering, or a specific process for making that product is contemplated, that product or process is first defined using a set of concept dimensions. This specific description is then treated as a first inventive concept and the appropriate awareness grid is consulted as in the novelty example of Example 15, with the important exception that only the claimed dimension fields are scrutinized. Disclosed dimension fields are not relevant for determination of right to practice. In fact, it is possible to construct macros which remove disclosed dimensions fields during assessment of practicability. Such a macro has been demonstrated for an EXCEL™ spreadsheet, allowing the user to toggle between a display for the purpose of assessing full disclosure to determine patentability (i.e., novelty and obviousness), or, alternatively, for the purpose of assessing claims only to determine practicability (i.e., right to practice).

Once records describing inventive concepts that may be at issue for practicability have been identified, those records should be brought to the attention of a patent practitioner for thorough scrutiny, which may, in some cases, extend to retention of outside counsel to render a formal opinion regarding right to practice.

TABLE 2
Awareness Grid A. Dispersions of Active Ingredients.

| | | A-A2 | A-A3 | | | A-A6 | A-D1-c | |
|---|---|---|---|---|---|---|---|---|
| | A-A1 | Priority | Issue | A-A4 | A-A5 | Inventors/ | Carrier | A-D1-d |
| | Source | Date | Date | Publ. Date | Assignee | Authors | Medium | Carrier Medium |
| # | Ancillary | Ancillary | Ancillary | Ancillary | Ancillary | Ancillary | Claimed | Disclosed |
| A-R1 | U.S. Pat. | Mar. 9, 1942 | Mar. 20, 1945 | Mar. 20, 1945 | Vick | Manchey, | aqueous | |
| | No. 2372159 | | | | Chemical | L. L.; | phase | |
| | | | | | | Schneller, | | |
| | | | | | | G. H. | | |
| A-R2 | U.S. Pat. | Jun. 23, 1947 | Aug. 12, 1952 | Aug. 12, 1952 | Shell | Garner, | mineral oil; | oil: mineral, vegetable, and |
| | No. 2606874 | | | | Development | P. J.; | spindle oil | animal oils based on C, H, |
| | | | | | | Winsor, | | or C, H, O, and can be |
| | | | | | | P. A. | | modified, e.g., chlorinated |
| | | | | | | | | hydrocarbon |
| A-R3 | GB1367430 | Feb. 11, 1972 | Sep. 18, 1974 | Sep. 18, 1974 | Syntex | | 2,2-dimethyl- | 2,2-dimethyl-1,3- |
| | | | | | | | 1,3-dioxolane- | dioxolane-4-methanol and |
| | | | | | | | 4-methanol | any paraffin from mineral |
| | | | | | | | and petrolatum | oil to paraffin waxes; |
| | | | | | | | ointment base; | optional cosolvent |
| | | | | | | | optional | alcholos, diols, polyhydric |
| | | | | | | | cosolvent | alcohols |
| A-R4 | U.S. Pat. | Mar. 30, 1966 | Oct. 0, 1970 | Oct. 20, 1970 | Stiefel | Cox, | water at 50- | water at 50-90 wt %; water- |
| | No. 3535422 | | | | Laboratories | R. M.; | 90 wt % of the | containing medium |
| | | | | | | Ciufo, | composition | substantially free of |
| | | | | | | L. R. | | dissolved benzoyl peroxide |

| | A-D2-c | A-D2-d | A-D3-c | A-D3-d | | |
|---|---|---|---|---|---|---|
| | Dispersed | Dispersed | Delivered | Delivered | A-D4-c | A-D4-d |
| | Phase Medium | Phase Medium | Ingredient | Ingredient | Dispersant | Dispersant |
| # | Claimed | Disclosed | Claimed | Disclosed | Claimed | Disclosed |
| A-R1 | lipophilic | lipids, hydrocarbon | pharmaceutical as | | cetyl quaternary | “onium” salts |
| | substance; | oils, essential oils, | 1-65% of | | ammonium compound | including |
| | emollient; oil; | esters, chlorinated | emollient oil | | having hydrophilic | quaternary |
| | | solvents, resins, | | | acid constituent as | ammonium, |
| | | sulphur, organic | | | anion | sulphonium, |
| | | sulphur compounds | | | | phosphonium; |
| | | | | | | especially |
| | | | | | | attached to C14- |
| | | | | | | 18 aliphatic |
| | | | | | | groups; also |
| | | | | | | C8-C18 |
| A-R2 | water | | none; claims are | | water-soluble | synthetic |
| | | | “consisting | | sulfate salt | organic |
| | | | essentially of” | | of a C7-C18 | emlsifying agent |
| | | | claims | | aliphatic alcohol; | including |
| | | | | | also C7-C14 | sulfated |
| | | | | | | aliphatic |
| | | | | | | alcohols |
| | | | | | | at least C7 |
| A-R3 | | | topically active | anti-inflammatory | pharmaceutically | glycerol fatty |
| | | | anti-inflammatory | topical steroids; | acceptable non- | acid esters; |
| | | | steroid; a pregn-4- | especially highly | ionic surfactant | glycol fatty |
| | | | ene-3,20-dione; 2′- | insoluble topical | | acid esters; |
| | | | substituted-pregn-4- | corticoids | | polyoxyethylene |
| | | | en-20-one pyrazole | | | fatty acid |
| | | | | | | esters and alchol |
| | | | | | | ethers; fatty acid |
| | | | | | | ethanol-amides |
| A-R4 | emollient at 2- | emollient at 2- | finely divided | finely divided | none; NOTE | advantageously |
| | 25 wt %, see | 25 wt %, see Claim | particles of | particles | transitional | contains |
| | Claim 1; | 1; preferably | crystalline benzoyl | (<0.25 mm) of | phrase in only | emulsifiers for |
| | C4-C24 alcohols; | saturated organic | peroxide = 1-25 | crystalline | independent | the aqueous |
| | C2-C3 glycols; | compounds; C4-C24 | wt % of composition, | benzoyl peroxide = | claim is CONSISTING | and non-aqueous |
| | sat. C112-C20 | alcohols; C2-C3 | also 5-10 wt %; may | 1-25 wt % of | OF, yet no dispersant | phases of |
| | fatty acids; | glycols; sat. | also contain 1-25 | composition, also | is explicitly stated | the composition, |
| | C12-C20 fatty | C112-C20 fatty | wt % of finely divided | 5-10 wt %; may also | in any claim. | e.g., |
| | acid lower alkyl | acids; C12-C20 fatty | sulfur, also 2-10 | contain 1-25 wt % of | | polyethylene |
| | and glycerol | acid lower alkyl and | wt % | finely divided | | glycol 1000 |
| | esters | glycerol esters | | sulfur, also 2-10 | | monnostearate |
| | | | | wt % | | |

| | | | | | | A-D7-d |
|---|---|---|---|---|---|---|
| | | | | A-D6-d | A-D7-c | Second |
| | A-D5-c | A-D5-d | A-D6-c | Second Stabilizing | Second Stabilizing | Stabilizing |
| | Dispersant Amount | Dispersant Amount | Second Stabilizing | Agent | Agent Amount | Agent Amount |
| # | Claimed | Disclosed | Agent Claimed | Disclosed | Claimed | Disclosed |
| A-R1 | < the equivalents | 0.15-0.6 equiv. | pectin: equivs. of | pectin; pectinic | | ˜1% of |
| | of pectin; 0.15- | relative to pectin; | pectin > equivs. of | acid; propyl amine | | aqueous |
| | 0.6 equiv. for | pref. equal to or | quaternary ammonium | pectate exhibits | | phase; |
| | each equiv. of | less than 0.2 equiv. | salt; pectin | emulsifying and | | |
| | pectin | | partially degraded | foam producing | | |
| | | | to pectinic acid | properties; | | |
| A-R2 | not specified | amount required to | 1,2-octanediol | 1,2-alkanediols | not | 1-25 vol % |
| | | give desired | | having at least | specified | of the oil |
| | | effect | | 7 carbons; | | component; >25 |
| | | | | preferably C7- | | vol % |
| | | | | C14; also mixtures | | possible |
| A-R3 | 0-15 wt %, | operable amount = | | | | |
| | based on total | 0-15 wt % based on | | | | |
| | weight of | ointment; preferred = | | | | |
| | ointment | 1-5 wt %; 0.1 wt % or | | | | |
| | | lower to as high as | | | | |
| | | 10 wt % | | | | |
| A-R4 | | no explicit statement | “without addition | none | | |
| | | of amount | of a stabilizer” | | | |
| | | | is explicitly claimed | | | |

TABLE 3
Awareness Grid B. Aqueous Emulsion and Microemulsion Polymerization.

| | | B-A2 | B-A3 | B-A4 | | B-A6 | B-D1-c |
|---|---|---|---|---|---|---|---|
| | B-A1 | Priority | Issue | Publ. | B-A5 | Inventors/ | Polymer Synthesis |
| | Source | Date | Date | Date | Assignee | Authors | Type |
| # | Ancillary | Ancillary | Ancillary | Ancillary | Ancillary | Ancillary | Claimed |
| B-R1 | Macromolecules | | | Nov. 1, 1987 | | Turro, N. J. | |
| | 1987, 20, 1216- | | | | | et al.; | |
| | 1221 | | | | | El-Asser, | |
| | | | | | | M. S. et al. | |
| B-R2 | Macromolecules | | | Sep. 1, 1986 | | Napper, D. H., | |
| | 1986, 19, 1303- | | | | | et al.; | |
| | 1308 | | | | | Pomery, J. P, | |
| | | | | | | et al. | |
| B-R3 | U.S. Pat. No. | Jun. 26, 1941 | Jun. 26, 1941 | Jun. 26, 1941 | B. F. | Fryling, C. F. | free radical |
| | 2313233 | | | | Goodrich | | polymerization using a |
| | | | | | | | diazo amino aryl |
| | | | | | | | initiator; no limitation |
| | | | | | | | to a reaction medium |
| | | | | | | | type, or to bulk; claim |
| | | | | | | | to aqueous emulsion |

| | | | | | B-D3-d | B-D4-c |
|---|---|---|---|---|---|---|
| | | B-D2-c | | B-D3-c | Dispersed | Free Radical |
| | B-D1-d | Carrier | B-D2-d | Dispersed Phase | Phase | Polymerizable |
| | Polymer Synthesis Type | Medium | Carrier Medium | Medium | Medium | Monomer |
| # | Disclosed | Claimed | Disclosed | Claimed | Disclosed | Claimed |
| B-R1 | microemulsion; UV-light | | water | | toluene/ | |
| | induced free radical | | | | pentanol/ | |
| | polymerization using a | | | | styrene: | |
| | photoinitiator | | | | 1.0/1.0/1.6 | |
| | | | | | (volume | |
| | | | | | ratio) | |
| B-R2 | conventional emulsion | | water | | seed particles | |
| | polymerization | | | | of p-MMA | |
| | | | | | having a | |
| | | | | | diam. = 68 | |
| | | | | | nm, or 92 nm | |
| B-R3 | free radical | water | water | not specifically | implies | a butadiene monomer |
| | polymerization using a | (emulsion); | (emulsion); | stated; when | monomer | AND any second |
| | diazo amino aryl | other media | aqueous | aqueous | droplets | unsaturated monomer |
| | initiator; optionally | not specified; | emulsion | emulsion is | which are | polymerizable with |
| | peroxides; homogeneous | no limitation | example given; | claimed, | converted to | the initiator; sec. |
| | disclosed without details; | stated | other media not | monomer | polymer | monomer can be ring- |
| | emulsion polymerization | | specified; no | droplets | particles for | substituted vinyl, |
| | disclosed with some | | limitation stated | converted to | emulsion case | acrylo nitriles, esters |
| | detail | | | polymer | | of acrylic acid, styrene, |
| | | | | particles are | | acrylonitrile |
| | | | | implied. | | |

| | B-D4-d | | | | | |
|---|---|---|---|---|---|---|
| | Free Radical | | B-D5-d | | | B-D7-d |
| | Polymerizable | B-D5-c | Free Radical | B-D6-c | B-D6-d | Dispersant |
| | Monomer | Free Radical Initiator | Initiator | Dispersant | Dispersant | Amount |
| # | Disclosed | Claimed | Disclosed | Claimed | Disclosed | Disclosed |
| B-R1 | styrene | | UV-light, | | sodium dodecyl | 0.67 g/10 |
| | | | wavelength = | | sulfate (SDS | ml water |
| | | | 303-323 nm, | | | |
| | | | intensity = | | | |
| | | | 0.58-3.6 W/cm2; | | | |
| | | | photoinitiator | | | |
| | | | dibenzyl ketone | | | |
| | | | concentration = | | | |
| | | | 0.5-2 mmol based | | | |
| | | | on water | | | |
| B-R2 | methyl methacrylate | | not specified; free | | not specified; | |
| | (MMA) | | radical may have | | probably the only | |
| | | | been contained in | | dispersant was that of | |
| | | | the seed polymer | | the seed polymer | |
| B-R3 | butadiene and its | a diazo amino aryl | a diazo amino aryl | | fatty acid soaps, | no ranges, or |
| | homologs and analogs; | compound; some | compounds like | | sodium oleate, | limitations |
| | second monomer is | claims to adding at | diazo amino | | palmitate, myristate; | given; |
| | ring-substitued vinyl, | least a portion 90.5 to | benzene, ortho, | | synthetic saponaceous | specific |
| | e.g., styrene vinyl | 1.25 wt % based on | meta, and para diazo | | materials sodium | reference to |
| | naphthalene; acrylo | monomers) of the diazo | amino toluenes; a | | lauryl sulfate, sodium | use of 150 |
| | nitriles; acrylic esters; | initiator prior to | second peroxide | | isobutyl naphthalene | parts a 5% |
| | vinyl ketones; | polymerization; | initiator may also be | | sulfated; sodium | aqueous |
| | vinylidene chloride; | peroxides NOT | used, e.g., benzoyl | | palmitate | solution of |
| | vinyl ethinyl alkyl | specifically claimed | peroxide | | | sodium |
| | carbinols; unsat. | | | | | palmitate |
| | hydrocarbons | | | | | with 75 parts |
| | | | | | | 1,3- |
| | | | | | | butadiene, 2 |
| | | | | | | parts |
| | | | | | | acrylonitrile, |
| | | | | | | 1.5 parts |
| | | | | | | diazo amino |
| | | | | | | benzene |

| | | | | | B-D9-c | B-D9-d |
|---|---|---|---|---|---|---|
| | | | | | Polymer | Polymer |
| | B-D7-c | B-D7-d | B-D8-c | B-D8-d | Molecular | Molecular |
| | Dispersant | Dispersant | Polymer | Polymer | Weight | Weight |
| # | Amount Claimed | Amount Disclosed | Claimed | Disclosed | Claimed | Disclosed |
| B-R1 | | 0.67 g/10 | | polystyrene | | Mw = 139,000 |
| | | ml water | | | | to 533,000; |
| | | | | | | Mn = 65,000- |
| | | | | | | 238,000 |
| B-R2 | | | | poly (methyl | | Mn = 870,000 |
| | | | | methacrylate) | | and 1,200,000 |
| B-R3 | | no ranges, or limitations | copolymers formable | copolymers prepared | | |
| | | given; specific | from the monomers | from the various | | |
| | | reference to use of 150 | are implied and | monomer combinations | | |
| | | parts a 5% aqueous | expected to be formed, | are disclosed as being | | |
| | | solution of sodium | but not explicitly | more flexible if at | | |
| | | palmitate with 75 parts | stated in claims | least a portion of | | |
| | | 1,3-butadiene, 2 parts | | diazo initiator is | | |
| | | acrylonitrile, 1.5 parts | | added before any | | |
| | | diazo amino benzene | | polymerization. | | |

| | B-D10-c | | | B-D12-c | B-D12-d |
|---|---|---|---|---|---|
| | Polymer Molecular | B-D11-c | B-D11-d | Polymer Particle | Polymer Particle |
| | Weight Distribution | Polymer Particle | Polymer Particle | Size Distribution | Size Distribution |
| # | Claimed | Size Claimed | Size Disclosed | Claimed | Disclosed |
| B-R1 | | | number ave. | | polydispersity |
| | | | diameter = 35-56 nm; | | of the PSD = 1.05-1.08 |
| B-R2 | | | diam ˜100 nm | | essentially |
| | | | | | monodisperse; |
| | | | | | coefficients of |
| | | | | | variation of 8 and 12% |
| B-R3 | | | | | |

TABLE 4
Awareness Grid C. Condensation Polymerization.

| | C-A1 | C-A2 | C-A3 | C-A4 | | C-A6 | C-D1-c | C-D1-d |
|---|---|---|---|---|---|---|---|---|
| | Pat./Appl. No., | Priority | Issue | Publ. | C-A5 | Inventors/ | Polymer Synthesis | Polymer Synthesis |
| | or journal ref | Date | Date | Date | Assignee | Authors | Type | Type |
| # | Ancillary | Ancillary | Ancillary | Ancillary | Ancillary | Ancillary | Claimed | Disclosed |
| C-R1 | U.S. Pat. No. | Jan. 14, | Dec. 3, | Dec. 3, | E. I. | Martin, | polycondensation | polycondensation in |
| | 2223916 | 1938 | 1940 | 1940 | Du Pont | E. L. | in solution in | organic solvent; |
| | | | | | | | organic solvent | spinning/extrusion |
| | | | | | | | | without solvent |
| C-R2 | U.S. Pat. No. | Oct. 4, | Apr. 8, | Apr. 8, | E. I. | MacDonald, | polycondensation | polycondensation in |
| | 2592447 | 1947 | 1952 | 1952 | Du Pont | R. N. | | solution in organic |
| | | | | | | | | solvent |
| C-R3 | Macromolecules | | | Sep. 1, | | Tomalia, | | polycondensation; |
| | 1986, 19, 2466- | | | 1986 | | D. A.; et al. | | starburst dendrimer |
| | 2468 | | | | | | | |

| | | | C-D3-c | C-D3-d | C-D4-c |
|---|---|---|---|---|---|
| | | C-D2-d | First Condensation | First Condensation | First Condensation |
| | C-D2-c | Solvent | Pre-monomer | Pre-monomer | Monomer |
| # | Solvent Claimed | Disclosed | Claimed | Disclosed | Claimed |
| C-R1 | | first cond. Polymer | X—Z—R—SO2X, | X—Z—R—SO2X, | a bifunctional |
| | | may be formed | where X = halogen, | where X = halogen, | sulphonamide product of |
| | | without solvent | Z = acidic group | Z = acidic group | the reaction of |
| | | (I.e., bulk); | —CO— or —SO2—, | —CO— or —SO2—, | first condensation pre- |
| | | polymerization | R = moiety free from | R = moiety free from | monomer with B—R′—NHR″, |
| | | may be carried out | non-benzenoid | non-benzenoid | wher B = an amide-forming |
| | | in solvent for | unsaturation, and | unsaturation, and | group, or a group capable |
| | | monomers (e.g., | having a chain of | having a chain of aat | of forming an amide- |
| | | alcohol) | aat least 3 caarbon | least 3 caarbon | forming group unpon |
| | | | atoms | atoms | hydrolysis, R′ is same |
| | | | | | type of group s R of |
| | | | | | the first pre-monomer, R″ |
| | | | | | is H or alkyl |
| C-R2 | | any inert substance | | | N-carboanhydride of an |
| | | which dissolve the | | | amino carboxylic acid of |
| | | N-caroanhydride at | | | radical length 3 to 4 |
| | | polymerization | | | |
| | | temperatures, e.g.: | | | |
| | | diethyl ethe, | | | |
| | | chloroform, benzene, | | | |
| | | chlorbenzene, | | | |
| | | tetrahydrofuran | | | |
| C-R3 | | no solvent | | NH3, or other | |
| | | disclosed; | | amine; if NH3, | |
| | | however a large | | reacts with methyl | |
| | | excess of | | acrylate to give core | |
| | | ethylenediamine is | | cmpd has 3 arms | |
| | | used during the | | terminated with | |
| | | amidation steps, | | methyl carboxyl | |
| | | and, as such may be | | ester group | |
| | | providing the dual | | | |
| | | fucntion of | | | |
| | | reactant and solvent. | | | |

| | | C-D5-c | | | | C-D7-c |
|---|---|---|---|---|---|---|
| | C-D4-d | Second | C-D5-d | C-D6-c | C-D6-d | Condensation |
| | First Condensation | Condensation | Second Condensation | Condensation | Condensation | Initiator |
| | Monomer | Monomer | Monomer | Initiator | Initiator | Amount |
| # | Disclosed | Claimed | Disclosed | Claimed | Disclosed | Claimed |
| C-R1 | these bifunctional | bifunctional amide- | bifunctional amide- | | | |
| | sulphonamides have | forming reactant in | forming reactant in | | | |
| | terminal groups which are | which the amide- | which the amide- | | | |
| | amide forming | forming groups are | forming groups are | | | |
| | (COOH, NH2, etc.) a | complementary to | complementary to | | | |
| | bifunctional | those in the | those in the | | | |
| | sulphonamide product of | bifunctional | bifunctional | | | |
| | the reaction of first | sulphonamide | sulphonamide | | | |
| | condensation pre-monomer | | | | | |
| | with B—R′—NHR″, | | | | | |
| | wher B = an amide-forming | | | | | |
| | group, or a group | | | | | |
| | capable of forming an | | | | | |
| | amide-forming group | | | | | |
| | unpon hydrolysis, R′ is | | | | | |
| | same type of group s R | | | | | |
| | of the first pre-monomer, | | | | | |
| | R″ is H or alkyl. | | | | | |
| C-R2 | examples of N- | | | amine | any amine | 0.001 to 1.0 |
| | carboanhydride of amino | | | compound | having H | mol % based |
| | carboxylic acid of | | | (0.001 to 1.0 | on the amino | on anhydride |
| | radical length 3 to 4: | | | mol % based | nitrogen and | |
| | those of alpha amino | | | on anhydride): | at most 2 | |
| | acids or protected | | | single | such nitrogens; | |
| | derivatives, e.g., | | | active H and | list of | |
| | valine, alanine, | | | no more than | amine | |
| | pipecolic acid, 1- | | | one aromatic | initiators, | |
| | aminocycloheptanecarb- | | | radical on | e.g.: primary | |
| | oxylic acid | | | each of 1 or | aliphatic | |
| | | | | 2 nitrogens | amines; | |
| | | | | | aromatic | |
| | | | | | amines; | |
| | | | | | diamines | |
| C-R3 | methyl acrylate | | ethylenediamine | | | |

| | C-D7-d | | | C-D9-c | |
|---|---|---|---|---|---|
| | Condensation | | | Polymer | C-D9-d |
| | Initiator | C-D8-c | C-D8-d | Molecular | Polymer Molecular |
| | Amount | Polymer | Polymer | Weight | Weight |
| # | Disclosed | Claimed | Disclosed | Claimed | Disclosed |
| C-R1 | | polyamide- | linear polyamide- | no limitation | |
| | | polysulpho- | polysulphonamide | for the | |
| | | namide | | polymer, but | |
| | | | | claim to an | |
| | | | | intrinsic | |
| | | | | viscosity of at | |
| | | | | least 0.4 for | |
| | | | | polymeris | |
| | | | | suitable for | |
| | | | | fiber formation | |
| C-R2 | 0.001 to 1.0 | linear amino acid | linear amino acid | | degree of |
| | mol % based | polymer | polymers; polyamides | | polymerization: no |
| | on anhydride; | | | | limit indicated; 200, |
| | 0.05-0.5 | | | | 2000; preferred |
| | preferred | | | | molecular weight are |
| | | | | | high enough to give |
| | | | | | tough products in |
| | | | | | reasonable cycle |
| | | | | | times |
| C-R3 | | | poly(amido amine) | | |
| | | | (poly(beta-alanines)); | | |
| | | | structure is starburst, | | |
| | | | having alternating | | |
| | | | monomers, each pair of | | |
| | | | which represents a | | |
| | | | “generation”; ˜10-20 | | |
| | | | Angstroms per generation | | |

TABLE 5
Synaptic Grid AB built by merging awareness grids A and B: includes
the union of the dimension sets of awareness grids A and B.

| | | Ancillary | | | | | | Dimensions Included in Each of Grids A and B | | | | | | | | | | | | | | |
|---|---|---|---|---|---|---|---|---|---|---|---|---|---|---|---|---|---|---|---|---|---|---|
| Grid | Rec. | Categories | | | | | | *1 | *2 | *3 | *4 | *5 | *6 | *7 | *8 | *9 | *10 | *11 | *12 | *13 | *14 | *15 |
| A | | A1 | A2 | A3 | A4 | A5 | A6 | D1 | D2 | D3 | D4 | D5 | D6 | D7 | | | | | | | | |
| B | | A1 | A2 | A3 | A4 | A5 | A6 | D2 | D3 | | D6 | D7 | | | D1 | D4 | D5 | D8 | D9 | D10 | D11 | D12 |
| A | R1 | a | a | a | a | a | a | c | c | c | c | c | c | d | | | | | | | | |
| A | R2 | a | a | a | a | a | a | c | c | c | c | c | c | d | | | | | | | | |
| A | R3 | a | a | a | a | a | a | c | | c | c | c | | | | | | | | | | |
| A | R4 | a | a | a | a | a | a | c | c | c | c | | | | | | | | | | | |
| B | R1 | a | | | a | | a | d | d | | d | d | | | d | d | d | d | d | d | d | d |
| B | R2 | a | | | a | | a | d | d | | d | | | | d | d | d | d | d | d | d | d |
| B | R3 | a | a | a | a | a | a | c | c | | d | d | | | c | c | c | c | | | | |

The column headings for dimensions include unique dimensions, indicated by asterisk, as well as the dimension number of that unique dimension when it is included in any of awareness grids A, B, and C.
The column headings for the unique dimensions are:
*1 ≡ Carrier Medium;
*2 ≡ Dispersed Phase Medium:
*3 ≡ Delivered Ingredient:
*4 ≡ Dispersant:
*5 ≡ Dispersant Amount;
*6 ≡ Second Stabilizing Agent:
*7 ≡ Second Stabilizing Agent Amount:
*8 ≡ Polymer Synthesis Type:
*9 ≡ Free Radical Polymerizable Monomer:
*10 ≡ Free Radical Initiator:
*11 ≡ Polymer:
*12 ≡ Polymer Molecular Weight:
*13 ≡ Polymer Molecular Weight Distribution:
*14 ≡ Polymer Particle Size:
*15 ≡ Polymer Particle Size Distribution.
Ancillary Categories are A-1 to A-6.
Awareness records of each of the awareness grids (e.g., record A-R3 of Awareness Grid A are indicated by an A in the Gird column and an R3 in the record (Rec.) column.
The presence of a “c” in a dimension column indicates that a claimed dimension value was entered for that record. The fact that what is claimed is, by definition, also disclosed means that every entry of “c” implies a “d” as well.
The presence of a “d” means a disclosed value was entered, but no claimed value was entered.

TABLE 6
Synaptic Grid AC formed by merging awareness grids A and C: includes
the union of the dimension sets of awareness grids A and C.

| | | Ancillary | | | | | | Dimensions Included in Each of Grids A and C | | | | | | | | | | | | | | | |
|---|---|---|---|---|---|---|---|---|---|---|---|---|---|---|---|---|---|---|---|---|---|---|---|
| Grid | Rec. | Categories | | | | | | *1 | *2 | *3 | *4 | *5 | *6 | 7* | *8 | *11 | *12 | *16 | *17 | *18 | *19 | *20 | *21 |
| A | | A1 | A2 | A3 | A4 | A5 | A6 | D1 | D2 | D3 | D4 | D5 | D6 | D7 | | | | | | | | | |
| C | | A1 | A2 | A3 | A4 | A5 | A6 | | | | | | | | D1 | D8 | D9 | D2 | D3 | D4 | D5 | D6 | D7 |
| A | R1 | a | a | a | a | a | a | c | c | c | c | c | c | d | | | | | | | | | |
| A | R2 | a | a | a | a | a | a | c | c | c | c | c | c | d | | | | | | | | | |
| A | R3 | a | a | a | a | a | a | c | | c | c | c | | | | | | | | | | | |
| A | R4 | a | a | a | a | a | a | c | c | c | c | | | | | | | | | | | | |
| C | R1 | a | a | a | a | a | a | | | | | | | | c | c | c | d | c | c | c | | |
| C | R2 | a | a | a | a | a | a | | | | | | | | c | c | d | d | | c | | c | c |
| C | R3 | a | | | a | | a | | | | | | | | d | d | | d | d | d | d | | |

The column headings for dimensions include unique dimensions, indicated by asterisk, as well as the dimension number of that unique dimension when it is included in any of awareness grids A, B, and C.
The column headings for the unique dimensions are:
*1 ≡ Carrier Medium;
*2 ≡ Dispersed Phase Medium:
*3 ≡ Delivered Ingredient:
*4 ≡ Dispersant:
*5 ≡ Dispersant Amount;
*6 ≡ Second Stabilizing Agent:
*7 ≡ Second Stabilizing Agent Amount:
*8 ≡ Polymer Synthesis Type:
*11 ≡ Polymer:
*12 ≡ Polymer Molecular Weight:
*16 ≡ Solvent:
*17 ≡ First Condensation Pre-monomer:
*18 ≡ First Condensation Monomer:
*19 ≡ Second Condensation Monomer:
*20 ≡ Condensation Initiator:
*21 ≡ Condensation Initiator Amount.
Ancillary Categories are A-1 to A-6. Awareness records of each of the awareness grids (e.g., record A-R3 of Awareness Grid A are indicated by an A in the Gird column and an R3 in the record (Rec.) column. The presence of a “c” in a dimension column indicates that a claimed dimension value was entered for that record. The fact that what is claimed is, by definition, also disclosed means that every entry of “c” implies a “d” as well.
The presence of a “d” means a disclosed value was entered, but no claimed value was entered.

TABLE 7
Synaptic Grid BC built by merging awareness grids B and C: includes
the union of the dimension sets of awareness grids B and C.

| | | | | | | | | Dimensions Included in Each of | | | | | | | |
|---|---|---|---|---|---|---|---|---|---|---|---|---|---|---|---|
| | | Ancillary | | | | | | Awareness Grids B and C | | | | | | | |
| Grid | Rec. | Categories | | | | | | *1 | *2 | *4 | *5 | *8 | *9 | *10 | *11 |
| B | | A1 | A2 | A3 | A4 | A5 | A6 | D2 | D3 | D6 | D7 | D1 | D4 | D5 | D8 |
| C | | A1 | A2 | A3 | A4 | A5 | A6 | | | | | D1 | | | D8 |
| B | R1 | a | | | a | | a | a | d | d | d | d | d | d | d |
| B | R2 | a | | | a | | a | a | d | d | | d | d | d | d |
| B | R3 | a | a | a | a | a | a | a | c | d | d | c | c | c | c |
| C | R1 | a | a | a | a | a | a | a | | | | c | | | c |
| C | R2 | a | a | a | a | a | a | a | | | | c | | | c |
| C | R3 | a | | | a | | a | a | | | | d | | | d |

| | | Dimensions Included in Each of | | | | | | | | | |
|---|---|---|---|---|---|---|---|---|---|---|---|
| | | Awareness Grids B and C | | | | | | | | | |
| Grid | Rec. | *12 | *13 | *14 | *15 | *16 | *17 | *18 | *19 | *20 | *21 |
| B | | D9 | D10 | D11 | D12 | | | | | | |
| C | | D9 | | | | D2 | D3 | D4 | D5 | D6 | D7 |
| B | R1 | d | d | d | d | | | | | | |
| B | R2 | d | d | d | d | | | | | | |
| B | R3 | | | | | | | | | | |
| C | R1 | c | | | | d | c | c | c | | |
| C | R2 | d | | | | d | | c | | c | c |
| C | R3 | | | | | d | d | d | d | | |

The column headings for dimensions include unique dimensions, indicated by asterisk, as well as the dimension number of that unique dimension when it is included in any of awareness grids A, B, and C.
The column headings for the unique dimensions are:
*1 ≡ Carrier Medium;
*2 ≡ Dispersed Phase Medium:
*4 ≡ Dispersant:
*5 ≡ Dispersant Amount;
*8 ≡ Polymer Synthesis Type:
*9 ≡ Free Radical Polymerizable Monomer:
*10 ≡ Free Radical Initiator:
*11 ≡ Polymer:
*12 ≡ Polymer Molecular Weight:
*13 ≡ Polymer Molecular Weight Distribution:
*14 ≡ Polymer Particle Size:
*15 ≡ Polymer Particle Size Distribution:
*16 ≡ Solvent:
*17 ≡ First Condensation Pre-monomer:
*18 ≡ First Condensation Monomer:
*19 ≡ Second Condensation Monomer:
*20 ≡ Condensation Initiator:
*21 ≡ Condensation Initiator Amount.
Ancillary Categories are A-1 to A-6. Awareness records of each of the awareness grids (e.g., record A-R3 of Awareness Grid A are indicated by an A in the Gird column and an R3 in the record (Rec.) column.
The presence of a “c” in a dimension column indicates that a claimed dimension value was entered for that record. The fact that what is claimed is, by definition, also disclosed means that every entry of “c” implies a “d” as well.
The presence of a “d” means a disclosed value was entered, but no claimed value was entered.

TABLE 8
Synaptic Grid ABC built by merging Awareness Grids A, B, and C: includes
the union of the dimension sets of awareness grids B and C.

| | | | | | | | | Dimensions Included in Each of | | | | | | | | | | |
|---|---|---|---|---|---|---|---|---|---|---|---|---|---|---|---|---|---|---|
| | | Ancillary | | | | | | Awareness Grids A, B, and C | | | | | | | | | | |
| Grid | Rec. | Categories | | | | | | *1 | *2 | *3 | *4 | *5 | *6 | *7 | *8 | *9 | *10 | *11 |
| A | | A1 | A2 | A3 | A4 | A5 | A6 | D1 | D2 | D3 | D4 | D5 | D6 | D7 | | | | |
| B | | A1 | A2 | A3 | A4 | A5 | A6 | D2 | D3 | | D6 | D7 | | | D1 | D4 | D5 | D8 |
| C | | A1 | A2 | A3 | A4 | A5 | A6 | | | | | | | | Dl | | | D8 |
| A | R1 | a | a | a | a | a | a | c | c | c | c | c | c | d | | | | |
| A | R2 | a | a | a | a | a | a | c | c | c | c | c | c | d | | | | |
| A | R3 | a | a | a | a | a | a | c | | c | c | c | | | | | | |
| A | R4 | a | a | a | a | a | a | c | c | c | c | | | | | | | |
| B | R1 | a | | | a | | a | d | d | | d | d | | | d | d | d | d |
| B | R2 | a | | | a | | a | d | d | | d | | | | d | d | d | d |
| B | R3 | a | a | a | a | a | a | c | c | | d | d | | | c | c | c | c |
| C | R1 | a | a | a | a | a | a | | | | | | | | c | | | c |
| C | R2 | a | a | a | a | a | a | | | | | | | | c | | | c |
| C | R3 | a | | | a | | a | | | | | | | | d | | | d |

Dimensions Included in Each of
Awareness Grids A, B, and C

| Grid | Rec. | *12 | *13 | *14 | *15 | *16 | *17 | *18 | *19 | *20 | *21 |
|---|---|---|---|---|---|---|---|---|---|---|---|
| A | | | | | | | | | | | |
| B | | D9 | D10 | D11 | D12 | | | | | | |
| C | | D9 | | | | D2 | D3 | D4 | D5 | D6 | D7 |
| A | R1 | | | | | | | | | | |
| A | R2 | | | | | | | | | | |
| A | R3 | | | | | | | | | | |
| A | R4 | | | | | | | | | | |
| B | R1 | d | d | d | d | | | | | | |
| B | R2 | d | d | d | d | | | | | | |
| B | R3 | | | | | | | | | | |
| C | R1 | c | | | | d | c | c | c | | |
| C | R2 | d | | | | d | | c | | c | c |
| C | R3 | | | | | d | d | d | d | | |

The column headings for dimensions include unique dimensions, indicated by asterisk, as well as the dimension number of that unique dimension when it is included in any of awareness grids A, B, and C.
The column headings for the unique dimensions are:
*1 ≡ Carrier Medium;
*2 ≡ Dispersed Phase Medium:
*3 ≡ Delivered Ingredient:
*4 ≡ Dispersant:
*5 ≡ Dispersant Amount;
*6 ≡ Second Stabilizing Agent:
*7 ≡ Second Stabilizing Agent Amount:
*8 ≡ Polymer Synthesis Type:
*9 ≡ Free Radical Polymerizable Monomer:
*10 ≡ Free Radical Initiator:
*11 ≡ Polymer:
*12 ≡ Polymer Molecular Weight:
*13 ≡ Polymer Molecular Weight Distribution:
*14 ≡ Polymer Particle Size:
*15 ≡ Polymer Particle Size Distribution:
*16 ≡ Solvent:
*17 ≡ First Condensation Pre-monomer:
*18 ≡ First Condensation Monomer:
*19 ≡ Second Condensation Monomer:
*20 ≡ Condensation Initiator:
*21 ≡ Condensation Initiator Amount.
Ancillary Categories are A-1 to A-6. Awareness records of each of the awareness grids (e.g., record A-R3 of Awareness Grid A are indicated by an A in the Gird column and an R3 in the record (Rec.) column.
The presence of a “c” in a dimension column indicates that a claimed dimension value was entered for that record. The fact that what is claimed is, by definition, also disclosed means that every entry of “c” implies a “d” as well.
The presence of a “d” means a disclosed value was entered, but no claimed value was entered.

1. An awareness grid, wherein said awareness grid comprises:
(a) a set of grid dimensions;
(b) at least one grid record; and
(c) optionally, one or more ancillary categories,
wherein said set of grid dimensions is a set of concept dimensions capable of describing at least one inventive concept; and
wherein said grid record comprises:
(i) a grid claimed field corresponding to each said grid dimension;
(ii) a grid disclosed field corresponding to each said grid dimension; and
(iii) optionally, one or more grid ancillary fields, each corresponding to a grid ancillary category.

2. The awareness grid of claim 1, wherein said grid claimed field contains a grid claimed value, or said grid disclosed field contains a grid disclosed value, or said grid ancillary field contains a grid ancillary value, or a combinations thereof.

3. The awareness grid of claim 1, wherein said awareness grid is an awareness database, or a synaptic grid, or a combination thereof.

4. A method of building the awareness grid according to claim 1, comprising the steps of:
(a) identifying a set of grid dimensions;
(b) forming one or more grid records, wherein said forming of said grid record comprises:
(i) creating a grid claimed field corresponding to each said grid dimension;
(ii) creating a grid disclosed field corresponding to each said grid dimension; and
(iii) creating a grid ancillary fields corresponding to each said grid ancillary category.

5. The method of claim 4, further comprising the step of populating said grid disclosed field with a grid disclosed dimension value for said grid inventive concept as described by a grid source to which said grid record corresponds, wherein said grid disclosed dimension value describes what is disclosed regarding said grid dimension to which it corresponds,

6. The method of claim 4, further comprising the step of populating said grid claimed field with a grid claimed dimension value for said grid inventive concept as described by a grid source to which said grid record corresponds, wherein said grid claimed dimension value describes what is claimed regarding said grid dimension to which it corresponds,

7. The method of claim 4, further comprising the step of populating said grid ancillary field with a grid ancillary value describing the grid source, or the contents of that grid source to which said grid record corresponds.

8. The method of claim 4, further comprising the step of comparing concept dimension values corresponding to a set of first concept dimensions, describing a first inventive concept, with said grid dimension values of said set of grid dimensions of one or more said grid records, wherein said grid dimension values of each said set of grid dimensions describe a second inventive concept.

9. The method of claim 8, wherein said comparing is for the purpose of making decisions regarding novelty, or obviousness, or right-to-practice of said first inventive concept compared to one or more said second inventive concepts.

10. The method of claim 4, comprising the further step of building a synaptic grid, wherein said step of building said synaptic grid comprises:
(a) forming a union of the sets of grid dimensions of two or more remote grids;
(b) adding at least one grid record derived from each of said remote grids; and
(c) adding to each said grid record said grid claimed field, and said grid disclosed field for each said grid dimension of said synaptic grid which is not a member of said set of grid dimensions of said remote grid from which said grid record was taken;
wherein:
two said awareness grids are said remote grids with respect to each other if said set of grid dimensions of one said awareness grid is not identical to said set of grid dimensions of the other said awareness grid, and neither of said sets of grid dimensions is a proper subset of the other.

11. The method of claim 10, further comprising a step of calculating a grand intersection value for said synaptic grid by:
(i) calculating a grid pair intersection value for every unique pairwise union of remote grids that can be used to form said synaptic grid;
(ii) summing said grid pair intersection values for all said unique pairwise unions to produce a grid pair intersection value sum; and
(iii) dividing said grid pair intersection value sum by the total number of said unique pairwise unions to yield said grand intersection value;
wherein said calculating of said grid pair intersection value for each said unique pairwise union is accomplished by:
(a) determining the number of members of the union set formed by a union of said set of grid dimensions of one said remote grid with said set of grid dimensions of another of said remote grids;
(b) determining the number of members of the intersection set of said union set; and
(c) dividing said number of members of said intersection set by said number of members of said union set to yield a result;
wherein said result is said grid pair intersection value for said pair of remote grids.

12. The method of claim 11, further comprising a step of calculating a grand tilt angle for said synaptic grid by:
(i) subtracting each said grid pair intersection value from 1 to produce a grid pair intersection remainder;
(ii) for each said remainder, multiplying said remainder by 90 degrees to produce a grid pair tilt angle;
(iii) summing said grid pair tilt angles for all said unique pairwise unions to produce a tilt angle sum; and
(iv) dividing said tilt angle sum by the total number of said unique pairwise unions to yield said grand tilt angle.

13. The method of claim 10 further comprising the step of forming one or more synaptic concepts by:
(i) identifying a nascent synaptic concept; and
(ii) forming said synaptic concept;
wherein said nascent synaptic concept is capable of being described by a set of intersecting dimensions of the union of two or more said sets of remote dimensions;
wherein said forming said synaptic concept comprises combining of said set of intersecting dimensions with one or more members of a set of non-intersecting dimensions of said union of said two or more said sets of remote dimensions; and
wherein said synaptic concept is capable of being described by a set of said intersecting dimensions and said non-intersecting dimensions.

14. The method of claim 4, further comprising the step of splitting said awareness grid into two or more remote grids,
wherein:
each said remote grid has said set of grid dimensions which is not identical to said set of grid dimensions of any of the other said remote grid, and is not a proper subset of said set of grid dimensions of any other said remote grid; and
any grid record of said remote grid comprises a grid claimed field and a grid disclosed field corresponding to each said grid dimension of said remote grid.

15. The method of claim 14, further comprising the step of combining two or more remote grids to build a synaptic grid, wherein said building a synaptic grid comprises:
(a) forming a union of said sets of grid dimensions of two or more said remote grids;
(b) adding at least one said grid record derived from each of said remote grids; and
(c) adding to each said grid record one said grid claimed field, and one said grid disclosed field for each said grid dimension of said synaptic grid which was not a member of said set of grid dimensions included in said remote grid from which said grid record was taken, thereby forming a synaptic record.

16. The method of claim 15, further comprising the step of gap analyzing said awareness grid, wherein said gap analyzing comprises forming one or more synaptic concepts by:
(i) adding a new said synaptic record to said synaptic grid;
(ii) populating said new synaptic record, wherein said populating comprises:
populating at least one claimed field corresponding to at least one member of a set of intersecting dimensions of said union of two or more said sets of remote dimensions to form said set of grid dimensions of said synaptic grid; and
populating at least one claimed field corresponding to at least one member of a set of grid dimensions which is disjoint with respect to said set of intersecting dimensions; and
(iii) comparing said set of grid dimension values contained in said new synaptic record with said set of grid inventive concepts described in one or more said grid records of said awareness grid for the purpose of making decisions regarding novelty, or obviousness, or right-to-practice of said synaptic concept compared to one or more said grid inventive concepts.

17. A synaptic grid comprised of two or more remote grids, wherein said remote grids are awareness grids according to claim 1, and each said remote grid has a set of grid dimensions having at least one dimension which is not a member of said set of grid dimensions of any other said remote grid of said synaptic grid.
